(19) United States
(12) Patent Application Publication
(10) Pub. No.: US 2008/0241518 A1
(43) Pub. Date: Oct. 2, 2008

(54) ORGANIC ELECTROLUMINESCENCE ELEMENT

(76) Inventors: Tasuku Satou, Kanagawa (JP); Hirofumi Fukunaga, Kanagawa (JP); Manabu Tobise, Kanagawa (JP)

Correspondence Address: BIRCH STEWART KOLASCH & BIRCH, PO BOX 747, FALLS CHURCH, VA, 22040-0747, US

(21) Appl. No.: 12/054,147

(22) Filed: Mar. 24, 2008

(30) Foreign Application Priority Data
Mar. 26, 2007 (JP) 2007-080253
Feb. 6, 2008 (JP) 2008-026984

(51) Int. Cl. B32B 7/02; B32B 9/00; C09K 11/00

(52) U.S. Cl. 428/332; 428/690

(57) ABSTRACT

An organic electroluminescence element having at least one organic layer including a light-emitting layer between a pair of electrodes, wherein the organic electroluminescence element has an electron transport layer containing a phosphine oxide compound and an electron transport layer that does not substantially contain the phosphine oxide compound between the light-emitting layer and a cathode, the electron transport layer containing the phosphine oxide compound is nearer to the cathode, and the electron transport layer that does not substantially contain the phosphine oxide compound is nearer to the light-emitting layer. An organic EL element that exhibits high light-emission efficiency and is excellent in drive durability is provided.

### CROSS-REFERENCE TO RELATED APPLICATION

This application claims priority under 35 USC 119 from Japanese Patent Application Nos. 2007-080253 and 2008-026984, the disclosures of which are incorporated by reference herein.

### BACKGROUND OF THE PRESENT INVENTION

1. Field of the Present Invention

The present invention relates to an organic electroluminescence element (hereinafter, referred to as an “organic EL element” in some cases) which can be effectively applied to a surface light source for full color displays, backlights, illumination light sources and the like; or a light source array for printers, and the like.

2. Description of the Related Art

An organic EL element is composed of a light-emitting layer or a plurality of organic layers containing a light-emitting layer, and a pair of electrodes sandwiching the organic layers. The organic EL element is a device for obtaining luminescence by utilizing at least either one of luminescence from excitons each of which is obtained by recombining an electron injected from a cathode with a hole injected from an anode to produce an exciton in the organic layer, or luminescence from excitons of other molecules produced by energy transmission from the above-described excitons.

Heretofore, an organic EL element has been developed by using a laminate structure from integrated layers in which each layer is functionally differentiated, whereby the brightness and the device efficiency are remarkably improved. For example, a two-layer laminated type device obtained by laminating a hole transport layer and a light-emitting layer also functioning as an electron transport layer; a three-layer laminated type device obtained by laminating a hole transport layer, a light-emitting layer, and an electron transport layer; and a four-layer laminated type device obtained by laminating a hole transport layer, a light-emitting layer, a hole-blocking layer, and an electron transport layer have been frequently used.

For the practical application of an organic EL element, however, there are still many problems such as improvement in light-emission efficiency and drive durability. Particularly, increase in light-emission efficiency results in a decrease in power consumption, and further, it is advantageous in view of drive durability. Accordingly, many means of improvement have been heretofore disclosed. However, a light-emitting material having a high light-emission efficiency usually has a disadvantage of causing brightness deterioration during driving thereof, and further, a material excellent in drive durability involves a disadvantage of low brightness. Accordingly, it is not easy to achieve both higher light-emission efficiency and higher drive durability, and thus, further improvements are sought.

Among these, a hole transport material for accelerating hole injection from an anode and hole transport, and an electron transport material for accelerating electron injection from a cathode and electron transport are sought. In particular, an electron transport material to which electrons can quickly be injected from a cathode and which is excellent in electron transportation property is needed. Japanese Patent Application Laid-Open (JP-A) No. 2006-73581, for example, discloses phosphine oxide compounds as an electron transport material excellent in electron transportation property. However, there is a problem in that electron transport materials having a low electron injection barrier from a cathode and a high electron mobility, including phosphine oxide compounds, have a low drive durability.

On the other hand, light-emitting materials having a high light-emission efficiency also are sought. For example, JP-A No. 2002-63989 and “New Charge Transporting Host Material for Short Wavelength Organic Electrophosphorescence: 2,7-Bis(diphenylphosphine oxide)-9,9-dimethyl-fluorene”, Chem. Mater., vol. 18, pages 2389 to 2396 (2006) disclose that phosphine oxide compounds are excellent in electron injection property and transportation property, and that, accordingly, improvement in light-emission efficiency and lowering of drive voltage may be expected due to the use of those compounds in a light-emitting layer. However, there is a problem in that, when a phosphine oxide compound is used as a host material of a light-emitting layer, drive durability is significantly degraded because the phosphine oxide compound deteriorates during continuous driving to lose the function as a host material.

Accordingly, the development of an organic EL element that has a high light-emission efficiency and is excellent in drive durability is needed.

### SUMMARY OF THE PRESENT INVENTION

The present invention has been made in view of the above circumstances and provides an organic electroluminescence element comprising at least one organic layer including a light-emitting layer between a pair of electrodes, wherein the organic electroluminescence element includes an electron transport layer containing a phosphine oxide compound and an electron transport layer that does not substantially contain the phosphine oxide compound between the light-emitting layer and a cathode, the electron transport layer containing the phosphine oxide compound is nearer to the cathode, and the electron transport layer that does not substantially contain the phosphine oxide compound is nearer to the light-emitting layer.

### DETAILED DESCRIPTION OF THE PRESENT INVENTION

A purpose of the present invention is to provide an organic EL element that exhibits high light-emission efficiency and is excellent in drive durability.

The present invention has been made in view of the above circumstances, and objects of the invention have been achieved by the following means.

An organic electroluminescence element according to the present invention comprises at least one organic layer including a light-emitting layer between a pair of electrodes, wherein the organic electroluminescence element includes an electron transport layer containing a phosphine oxide compound and an electron transport layer that does not substantially contain the phosphine oxide compound between the light-emitting layer and a cathode, the electron transport layer containing the phosphine oxide compound is nearer to the cathode, and the electron transport layer that does not substantially contain the phosphine oxide compound is nearer to the light-emitting layer.

Preferably, the electron transport layer containing the phosphine oxide compound is a layer which contacts with an electron injection layer.

Preferably, the thickness of the electron transport layer containing the phosphine oxide compound is from 0.01 nm to 10 nm, and more preferably from 0.01 nm to 5 nm.

Preferably, the phosphine oxide compound is a compound represented by the following formula (I).

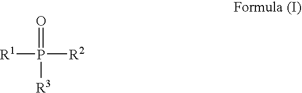

In formula (I), R¹, R² and R³ each independently represent an alkyl group, an alkenyl group, an alkynyl group, an aryl group, an amino group, an alkoxy group, an aryloxy group, a heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a heterocyclic thio group or a heterocyclic group.

Further preferably, the phosphine oxide compound represented by formula (I) is a compound represented by the following formula (III).

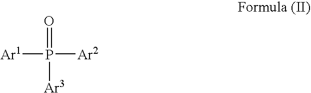

In formula (II), Ar¹, Ar² and Ar³ each independently represent an aryl group or a heterocyclic group.

Another preferable embodiment of the phosphine oxide compound is a compound represented by the following formula (III).

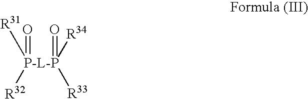

In formula (III), R³¹ to R³⁴ each independently represent an aryl group or a heterocyclic group, and L represents a divalent linking group.

Preferably, the light-emitting layer contains a phosphorescent light-emitting material. More preferably, the phosphorescent light-emitting material is an organic metal complex including platinum as a central metal.

Preferably, the light-emitting layer contains a hole transporting organic material as a host material.

By the present invention, an organic EL element having a high light-emission efficiency and an excellent drive durability is provided.

Hereinafter, the organic EL element of the invention is described in detail.

The light-emitting element of the invention has a cathode and an anode on a substrate, and at least one organic compound layer including an organic light-emitting layer (hereinafter, sometimes simply referred to as a “light-emitting layer”) between the two electrodes. Due to the nature of a light-emitting element, at least one electrode of the anode and the cathode is preferably transparent.

The organic compound layer in the invention may be either of a monolayer or an integrated layer. In the case of an integrated layer, a preferable embodiment has a hole transport layer, a light-emitting layer and an electron transport layer integrated in this order from the anode side. In addition, a charge-blocking layer or the like may be provided between the hole transport layer and the light-emitting layer, or between the light-emitting layer and the electron transport layer. A hole injection layer may be provided between the anode and the hole transport layer. An electron injection layer may be disposed between the cathode and the electron transport layer. Further, each of the layers may be composed of plural secondary layers.

### 1. Description of the Phosphine Oxide Compound

Next, the phosphine oxide compound for use in the organic electroluminescence element of the invention is described in detail.

The phosphine oxide compound for use in the invention is preferably a compound represented by the following formula (I).

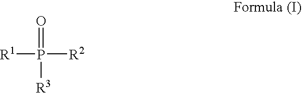

In formula (I), R¹, R² and R³ each independently represent an alkyl group, an alkenyl group, an alkynyl group, an aryl group, an amino group, an alkoxy group, an aryloxy group, a heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a heterocyclic thio group or a heterocyclic group.

More preferably, the phosphine oxide compound for use in the invention is a compound represented by the following formula (II).

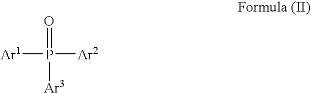

In formula (II), Ar¹, Ar² and Ar³ each independently represent an aryl group or a heterocyclic group.

Still another group of preferable phosphine oxide compounds in the invention is a group of compounds represented by the following formula (III).

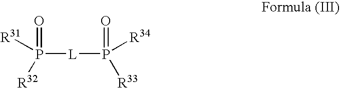

In formula (III), R³¹ to R³⁴ each independently represent an aryl group or a heterocyclic group. L represents a divalent linking group.

Formula (I) is described in detail.

Each of R¹, R² and R³ is an alkyl group (having preferably 1 to 30 carbon atoms, more preferably 1 to 20 carbon atoms, and particularly preferably 1 to 10 carbon atoms, including, for example, methyl, ethyl, iso-propyl, tert-butyl, n-octyl, n-decyl, n-hexadecyl, cyclopropyl, cyclopentyl, cyclohexyl and the like), an alkenyl group (having preferably 2 to 30 carbon atoms, more preferably 2 to 20 carbon atoms, and particularly preferably 2 to 10 carbon atoms, including, for example, vinyl, allyl, 2-butenyl, 3-pentenyl and the like), an alkynyl group (having preferably 2 to 30 carbon atoms, more preferably 2 to 20 carbon atoms, and particularly preferably 2 to 10 carbon atoms, including, for example, propargyl, 3-pentynyl and the like), an aryl group (having preferably 6 to 30 carbon atoms, more preferably 6 to 20 carbon atoms, and particularly preferably 6 to 12 carbon atoms, including, for example, phenyl, p-methyl phenyl, naphthyl, anthryl and the like), an amino group (having preferably 0 to 30 carbon atoms, more preferably 0 to 20 carbon atoms, and particularly preferably 0 to 10 carbon atoms, including, for example, amino, methyl amino, dimethyl amino, diethyl amino, dibenzyl amino, diphenyl amino, ditolyl amino and the like), an alkoxy group (having preferably 1 to 30 carbon atoms, more preferably 1 to 20 carbon atoms, and particularly preferably 1 to 10 carbon atoms, including, for example, methoxy, ethoxy, butoxy, 2-ethylhexyloxy and the like), an aryloxy group (having preferably 6 to 30 carbon atoms, more preferably 6 to 20 carbon atoms, and particularly preferably 6 to 12 carbon atoms, including, for example, phenyloxy, 1-naphthyloxy, 2-naphthyloxy and the like), a heterocyclic oxy group (having preferably 1 to 30 carbon atoms, more preferably 1 to 20 carbon atoms, and particularly preferably 1 to 12 carbon atoms, including, for example, pyridyloxy, pyrazyloxy, pyrimidyloxy, quinolyloxy and the like), an acyl group (having preferably 1 to 30 carbon atoms, more preferably 1 to 20 carbon atoms, and particularly preferably 1 to 12 carbon atoms, including, for example, acetyl, benzoyl, formyl, pivaloyl and the like), an alkoxycarbonyl group (having preferably 2 to 30 carbon atoms, more preferably 2 to 20 carbon atoms, and particularly preferably 2 to 12 carbon atoms, including, for example, methoxycarbonyl, ethoxycarbonyl and the like), an aryloxycarbonyl group (having preferably 7 to 30 carbon atoms, more preferably 7 to 20 carbon atoms, and particularly preferably 7 to 12 carbon atoms, including, for example, phenyloxycarbonyl and the like), an acyloxy group (having preferably 2 to 30 carbon atoms, more preferably 2 to 20 carbon atoms, and particularly preferably 2 to 10 carbon atoms, including, for example, acetoxy, benzoyloxy and the like), an acylamino group (having preferably 2 to 30 carbon atoms, more preferably 2 to 20 carbon atoms, and particularly preferably 2 to 10 carbon atoms, including, for example, acetylamino, benzoylamino and the like), an alkoxycarbonylamino group (having preferably 2 to 30 carbon atoms, more preferably 2 to 20 carbon atoms, and particularly preferably 2 to 12 carbon atoms, including, for example, methoxycarbonylamino and the like), an aryloxycarbonylamino group (having preferably 7 to 30 carbon atoms, more preferably 7 to 20 carbon atoms, and particularly preferably 7 to 12 carbon atoms, including, for example, phenyloxycarbonylamino and the like), a sulfonylamino group (having preferably 1 to 30 carbon atoms, more preferably 1 to 20 carbon atoms, and particularly preferably 1 to 12 carbon atoms, including, for example, methanesulfonylamino, benzenesulfonylamino and the like), a sulfamoyl group (having preferably 0 to 30 carbon atoms, more preferably 0 to 20 carbon atoms, and particularly preferably 0 to 12 carbon atoms, including, for example, sulfamoyl, methylsulfamoyl, dimethylsulfamoyl, phenylsulfamoyl and the like), a carbamoyl group (having preferably 1 to 30 carbon atoms, more preferably 1 to 20 carbon atoms, and particularly preferably 1 to 12 carbon atoms, including, for example, carbamoyl, methylcarbamoyl, diethylcarbamoyl, phenylcarbamoyl and the like), an alkylthio group (having preferably 1 to 30 carbon atoms, more preferably 1 to 20 carbon atoms, and particularly preferably 1 to 12 carbon atoms, including, for example, methylthio, ethylthio and the like), an arylthio group (having preferably 6 to 30 carbon atoms, more preferably 6 to 20 carbon atoms, and particularly preferably 6-12 carbon atoms, including, for example, phenylthio and the like), a heterocyclic thio group (having preferably 1 to 30 carbon atoms, more preferably 1 to 20 carbon atoms, and particularly preferably 1 to 12 carbon atoms, including, for example, pyridylthio, 2-benzimidazolylthio, 2-benzoxazolylthio, 2-benzthiazolylthio and the like), a heterocyclic group (having preferably 1 to 30 carbon atoms, and more preferably 1 to 12 carbon atoms, which contains, for example, a nitrogen atom, an oxygen atom and a sulfur atom as a hetero atom, including, more specifically, an imidazolyl, pyridyl, quinolyl, furyl, thienyl, piperidyl, morpholino, benzoxazolyl, benzimidazolyl, benzthiazolyl, carbazolyl, azepinyl and the like), a silyl group (having preferably 3 to 40 carbon atoms, more preferably 3 to 30 carbon atoms, and particularly preferably 3 to 24 carbon atoms, including, for example, trimethylsilyl, triphenylsilyl and the like), a silyloxy group (having preferably 3 to 40 carbon atoms, more preferably 3 to 30 carbon atoms, and particularly preferably 3 to 24 carbon atoms, including, for example, trimethylsilyloxy, triphenylsilyloxy and the like), or a phosphoryl group (including, for example, diphenylphosphoryl, dimethylphosphoryl and the like).

Groups represented by R¹, R² and R³ may be the same or different from each other. Specific examples of the substituent represented by R¹, R² and R³ include preferably an alkyl group, an alkenyl group, an alkynyl group, an aryl group and a heterocyclic group, more preferably an alkyl group, an aryl group and a heterocyclic group, and particularly preferably an aryl group and a heterocyclic group.

Each of the substituents represented by R¹, R² and R³ may further have a substituent. Examples of applicable substituents include an alkyl group (having preferably 1 to 30 carbon atoms, more preferably 1 to 20 carbon atoms, and particularly preferably 1 to 10 carbon atoms, including, for example, methyl, ethyl, iso-propyl, tert-butyl, n-octyl, n-decyl, n-hexadecyl, cyclopropyl, cyclopentyl, cyclohexyl and the like), an alkenyl group (having preferably 2 to 30 carbon atoms, more preferably 2 to 20 carbon atoms, and particularly preferably 2-10 carbon atoms, including, for example, vinyl, allyl, 2-butenyl, 3-pentenyl and the like), an alkynyl group (having preferably 2 to 30 carbon atoms, more preferably 2 to 20 carbon atoms, and particularly preferably 2 to 10 carbon atoms, including, for example, propargyl, 3-pentynyl and the like), an aryl group (having preferably 6 to 30 carbon atoms, more preferably 6 to 20 carbon atoms, and particularly preferably 6 to 12 carbon atoms, including, for example, phenyl, p-methylphenyl, naphthyl, anthryl and the like), an amino group (having preferably 0 to 30 carbon atoms, more preferably 0 to 20 carbon atoms, and particularly preferably 0 to 10 carbon atoms, including, for example, amino, methylamino, dimethylamino, diethylamino, dibenzylamino, diphenylamino, ditolylamino and the like), an alkoxy group (having preferably 1 to 30 carbon atoms, more preferably 1 to 20 carbon atoms, and particularly preferably 1 to 10 carbon atoms, including, for example, methoxy, ethoxy, butoxy, 2-ethylhexyloxy and the like), an aryloxy group (having preferably 6 to 30 carbon atoms, more preferably 6 to 20 carbon atoms, and particularly preferably 6 to 12 carbon atoms, including, for example, phenyloxy, 1-naphthyloxy, 2-naphthyloxy and the like), a heterocyclic oxy group (having preferably 1 to 30 carbon atoms, more preferably 1 to 20 carbon atoms, and particularly preferably 1 to 12 carbon atoms, including, for example, pyridyloxy, pyrazyloxy, pyrimidyloxy, quinolyloxy and the like), an acyl group (having preferably 1 to 30 carbon atoms, more preferably 1 to 20 carbon atoms, and particularly preferably 1 to 12 carbon atoms, including, for example, acetyl, benzoyl, formyl, pivaloyl and the like), an alkoxycarbonyl group (having preferably 2 to 30 carbon atoms, more preferably 2 to 20 carbon atoms, and particularly preferably 2 to 12 carbon atoms, including, for example, methoxycarbonyl, ethoxycarbonyl and the like), an aryloxycarbonyl group (having preferably 7 to 30 carbon atoms, more preferably 7 to 20 carbon atoms, and particularly preferably having 7 to 12 carbon atoms, including, for example, phenyloxycarbonyl and the like), an acyloxy group (having preferably 2 to 30 carbon atoms, more preferably 2 to 20 carbon atoms, and particularly preferably 2 to 10 carbon atoms, including, for example, acetoxy, benzoyloxy and the like), an acylamino group (having preferably 2 to 30 carbon atoms, more preferably 2 to 20 carbon atoms, and particularly preferably 2 to 10 carbon atoms, including, for example, acetylamino, benzoylamino and the like), an alkoxycarbonylamino group (having preferably 2 to 30 carbon atoms, more preferably 2 to 20 carbon atoms, and particularly preferably 2 to 12 carbon atoms, including, for example, methoxycarbonylamino and the like), an aryloxycarbonylamino group (having preferably 7 to 30 carbon atoms, more preferably 7 to 20 carbon atoms, and particularly preferably 7 to 12 carbon atoms, including, for example, phenyloxycarbonylamino and the like), a sulfonylamino group (having preferably 1 to 30 carbon atoms, more preferably 1 to 20 carbon atoms, and particularly preferably 1 to 12 carbon atoms, including, for example, methanesulfonylamino, benzenesulfonylamino and the like), a sulfamoyl group (having preferably 0-30 carbon atoms, more preferably 0 to 20 carbon atoms, and particularly preferably 0-12 carbon atoms, including, for example, sulfamoyl, methylsulfamoyl, dimethylsulfamoyl, phenylsulfamoyl and the like), a carbamoyl group (having preferably 1 to 30 carbon atoms, more preferably 1 to 20 carbon atoms, and particularly preferably 1 to 12 carbon atoms, including, for example, carbamoyl, methylcarbamoyl, diethylcarbamoyl, phenylcarbamoyl and the like), an alkylthio group (having preferably 1-30 carbon atoms, more preferably 1 to 20 carbon atoms, and particularly preferably 1 to 12 carbon atoms, including, for example, methylthio, ethylthio and the like), an arylthio group (having preferably 6 to 30 carbon atoms, more preferably 6 to 20 carbon atoms, and particularly preferably 6 to 12 carbon atoms, including, for example, phenylthio and the like), a heterocyclic thio group (having preferably 1 to 30 carbon atoms, more preferably 1 to 20 carbon atoms, and particularly preferably 1 to 12 carbon atoms, including, for example, pyridylthio, 2-benzimidazolylthio, 2-benzoxazolylthio, 2-benzthiazolylthio and the like), a sulfonyl group (having preferably 1 to 30 carbon atoms, more preferably 1 to 20 carbon atoms, and particularly preferably 1 to 12 carbon atoms, including, for example, mesyl, tosyl and the like), a sulfinyl group (having preferably 1 to 30 carbon atoms, more preferably 1 to 20 carbon atoms, and particularly preferably 1 to 12 carbon atoms, including, for example, methanesulfinyl, benzenesulfinyl and the like), a ureido group (having preferably 1 to 30 carbon atoms, more preferably 1 to 20 carbon atoms, and particularly preferably 1 to 12 carbon atoms, including, for example, ureido, methylureido, phenylureido and the like), a phosphoric amido group (having preferably 1 to 30 carbon atoms, more preferably 1 to 20 carbon atoms, and particularly preferably 1 to 12 carbon atoms, including, for example, diethyl phosphoric amido, phenyl phosphoric amido and the like), a hydroxy group, a mercapto group, a fluoro group, a chloro group, a bromo group, an iodo group, a cyano group, a sulfo group, a carboxyl group, a nitro group, a hydroxamic acid group, a sulfino group, a hydrazino group, an imino group, a heterocyclic group (having preferably 1-30 carbon atoms, and more preferably 1-12 carbon atoms, which contains, for example, a nitrogen atom, an oxygen atom or a sulfur atom as a hetero atom, including, specifically, imidazolyl, pyridyl, quinolyl, furyl, thienyl, piperidyl, morpholino, benzoxazolyl, benzimidazolyl, benzthiazolyl, carbazolyl, azepinyl and the like), a silyl group (having preferably 3 to 40 carbon atoms, more preferably 3 to 30 carbon atoms, and particularly preferably 3 to 24 carbon atoms, including, for example, trimethylsilyl, triphenylsilyl and the like), a silyloxy group (having preferably 3 to 40 carbon atoms, more preferably 3 to 30 carbon atoms, and particularly preferably 3 to 24 carbon atoms, including, for example, trimethylsilyloxy, triphenylsilyloxy and the like), and a phosphoryl group (including, for example, diphenylphosphoryl, dimethylphosphoryl and the like).

The substituent held by the groups represented by R¹, R² or R³ is preferably an alkyl group, an alkenyl group, an alkynyl group, an aryl group, an amino group, an alkoxy group, an aryloxy group, a heterocyclic oxy group, an alkylthio group, an arylthio group, a heterocyclic thio group, a sulfonyl group, a sulfinyl group, a fluoro group, a chloro group, a bromo group, an iodo group, a cyano group, a heterocyclic group, a silyl group, a silyloxy group or a phosphoryl group, more preferably an alkyl group, an alkenyl group, an aryl group, an amino group, an alkoxy group, an aryloxy group, a heterocyclic oxy group, a sulfonyl group, a fluoro group, a cyano group, a heterocyclic group, a silyl group, a silyloxy group or a phosphoryl group, even more preferably an alkyl group, an aryl group, an amino group, a fluoro group, a cyano group, a heterocyclic group, a silyl group or a phosphoryl group, and further preferably an alkyl group, an aryl group, a cyano group, a heterocyclic group or a phosphoryl group.

Compounds represented by formula (I) are more preferably compounds represented by the following formula (II):

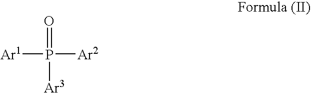

In formula (II), Ar¹, Ar² and Ar³ each independently represent an aryl group or a heterocyclic group.

Next, formula (II) is described in detail.

In the formula, Ar¹, Ar² and Ar³ each independently represent a substituted or unsubstituted aryl group or heterocyclic group. Specific examples of the aryl group represented by Ar¹, Ar² or Ar³ include a phenyl group, a naphthyl group, an anthryl group, a phenanthryl group, a pyrenyl group, a perylenyl group, a fluoranthenyl group, a fluorenyl group, a chrysenyl group, a tetracenyl group, a pentacenyl group, a triphenylenyl group, a tetraphenylenyl group and the like. These aryl groups may have a substituent. As the substituent, those mentioned as a substituent held by the groups represented by R¹, R² and R³ in formula (I) can be applied, which also have the similar preferable range.

Specific examples of the heteroaryl group represented by Ar¹, Ar² or Ar³ include a pyridyl group, a pyrazinyl group, a triazinyl group, a pyrimidinyl group, a pyridazinyl group, a quinolyl group, a quinoxalinyl group, a phthalazinyl group, a quinazolinyl group, a cinnolinyl group, a isoquinolyl group, an acridinyl group, a phenanthridinyl group, a phenanthrolinyl group, a pteridinyl group, an imidazopyridyl group, a pyrrolyl group, an indolyl group, a pyrazolyl group, an indazolyl group, an imidazolyl group, a benzimidazolyl group, a carbazolyl group, a carbolinyl group, a purinyl group, a furyl group, a thienyl group, an isoxazolyl group, an isothiazolyl group, an oxazolyl group, a thiazolyl group, a benzoxazolyl group, a benzothiazolyl group, an indolidinyl group, a benzoquinolinyl group, a quinolidinyl group, a triazolyl group, a benzotriazolyl group, an naphthylidinyl group and the like. These heteroaryl groups may have a substituent. As the substituent, those mentioned as a substituent held by the groups represented by R¹, R² and R³ in formula (I) can be applied, which also have the similar preferable range.

The group represented by Ar¹, Ar² or Ar³ is preferably a substituted or unsubstituted phenyl group, naphthyl group, anthryl group, phenanthryl group, pyrenyl group, fluorenyl group, pyridyl group, pyrazinyl group, quinolyl group, quinoxalinyl group, acridinyl group, phenanthrolinyl group or benzoquinolinyl group, and more preferably a substituted or unsubstituted phenyl group, naphthyl group, anthryl group, phenanthryl group, pyrenyl group, pyridyl group, pyrazinyl group, quinolyl group, phenanthrolinyl group or benzoquinolinyl group.

A more preferable group of phosphine oxide compounds in the invention is a group of compounds represented by the following formula (III).

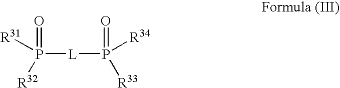

In formula (III), R³¹ to R³⁴ each independently represents an aryl group or a heterocyclic group. L represents a divalent linking group.

Next, formula (III) is described in detail.

In formula (III), the aryl group or heterocyclic group represented by R³¹ to R³⁴ is the same as the aryl group or heterocyclic group described for R¹ to R³ in formula (I) and also has the similar preferable range. L represents a divalent linking group. The divalent linking group is a linking group preferably comprising a carbon atom, a nitrogen atom, an oxygen atom, a sulfur atom, a silicon atom or a halogen atom, and more preferably comprising a carbon atom, a nitrogen atom or a silicon atom, although it is not particularly limited.

Specific examples of the divalent linking group represented by L naphthalene-di-yl, fluorene-di-yl, dibenzofuran-di-yl, pyridine-di-yl and pyrazine-di-yl, and more preferably biphenyl-di-yl, fluorene-di-yl, pyridine-di-yl and pyrazine-di-yl.

Specific examples of the phosphine oxide compound to be used in the present invention are shown below, but compounds in the invention are not limited thereto.

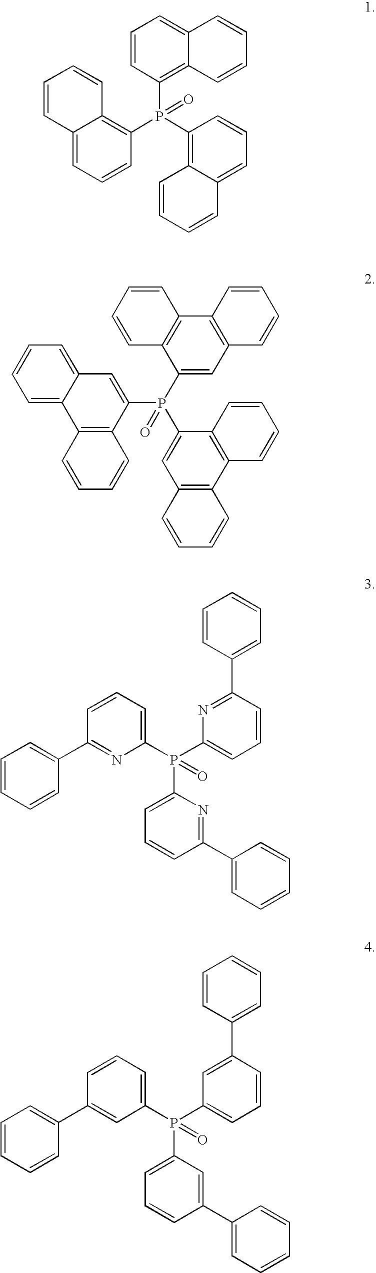

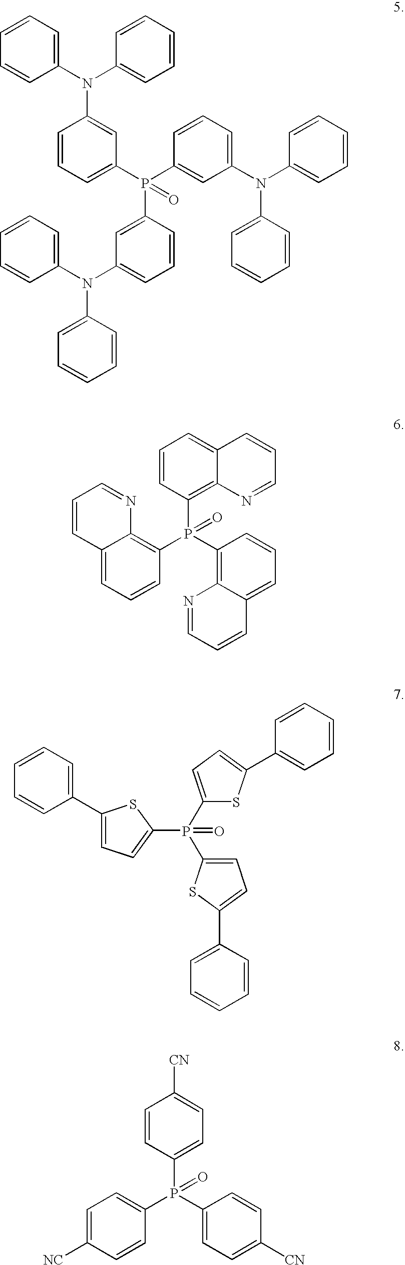

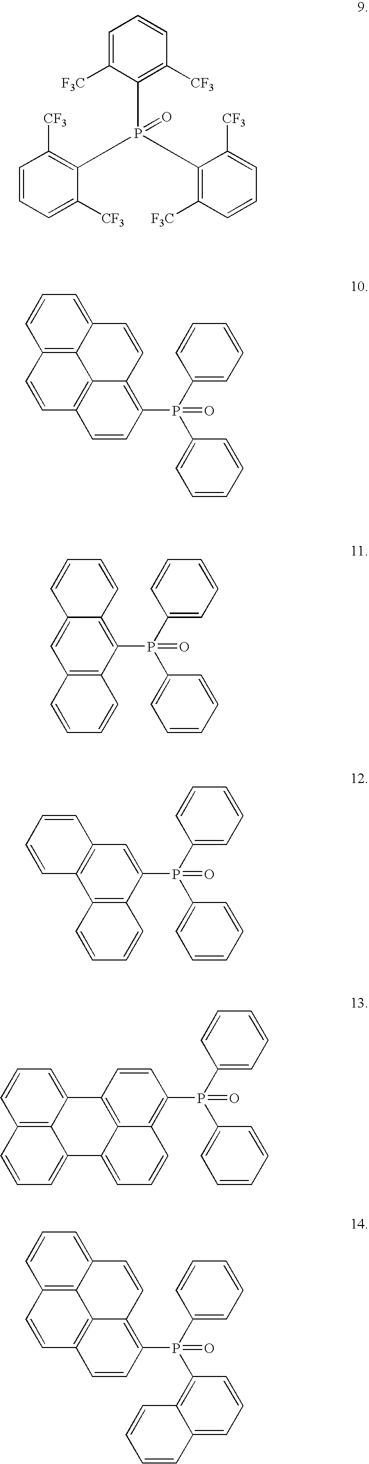

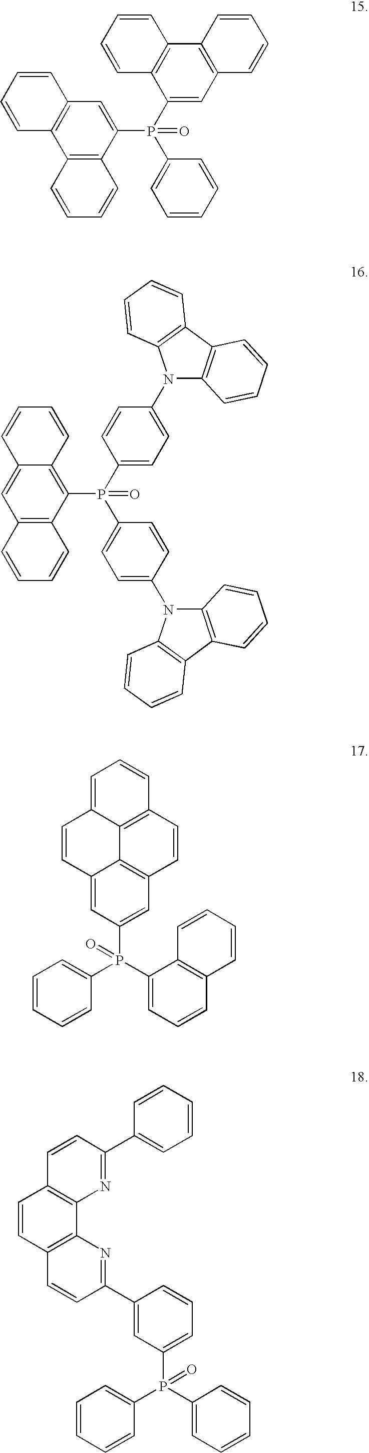

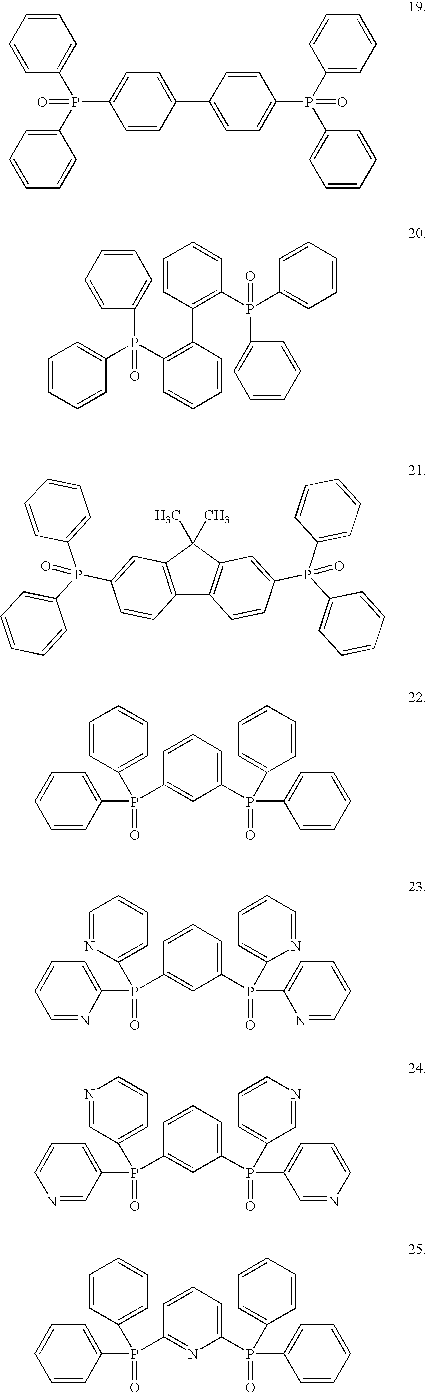

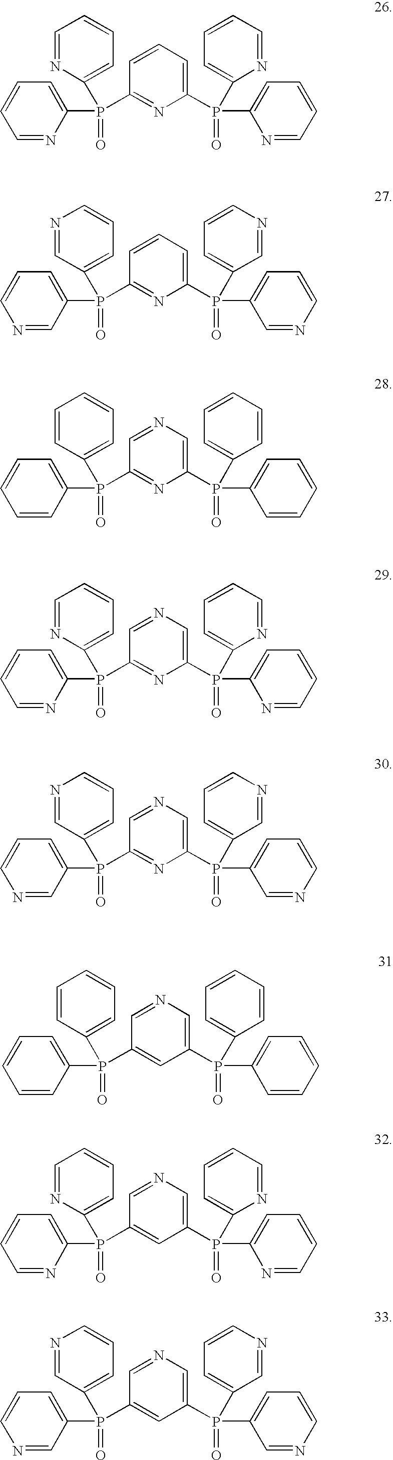

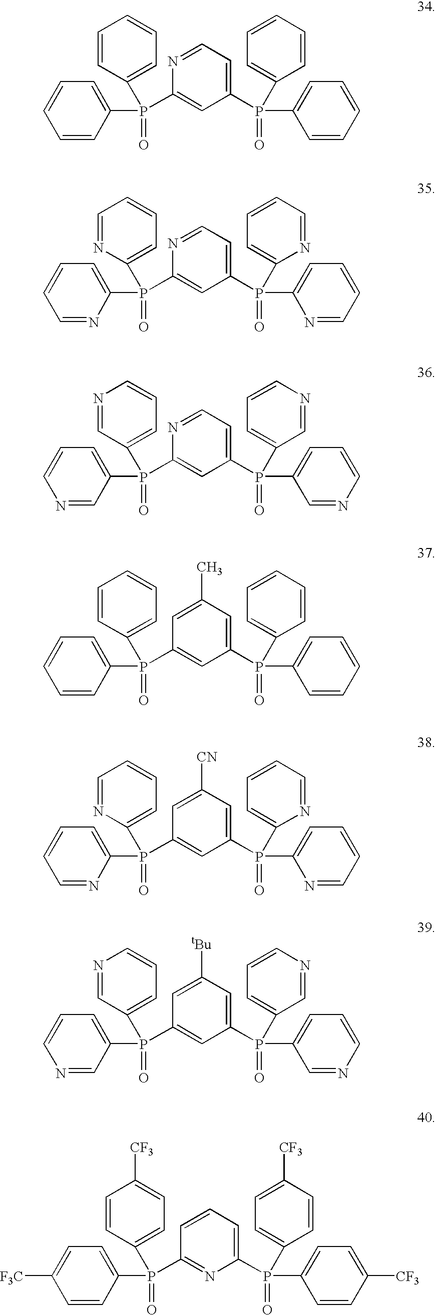

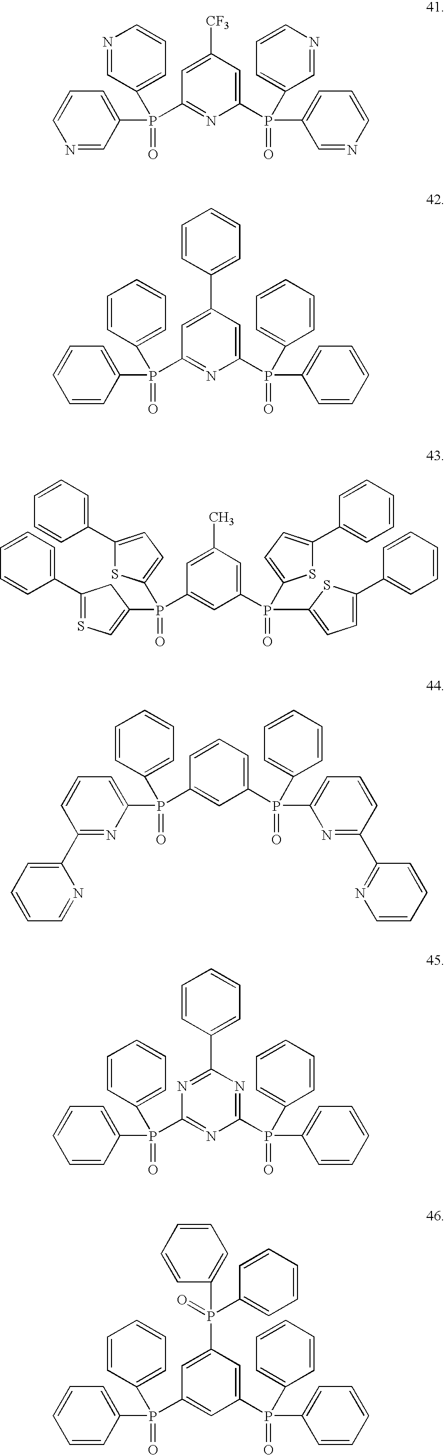

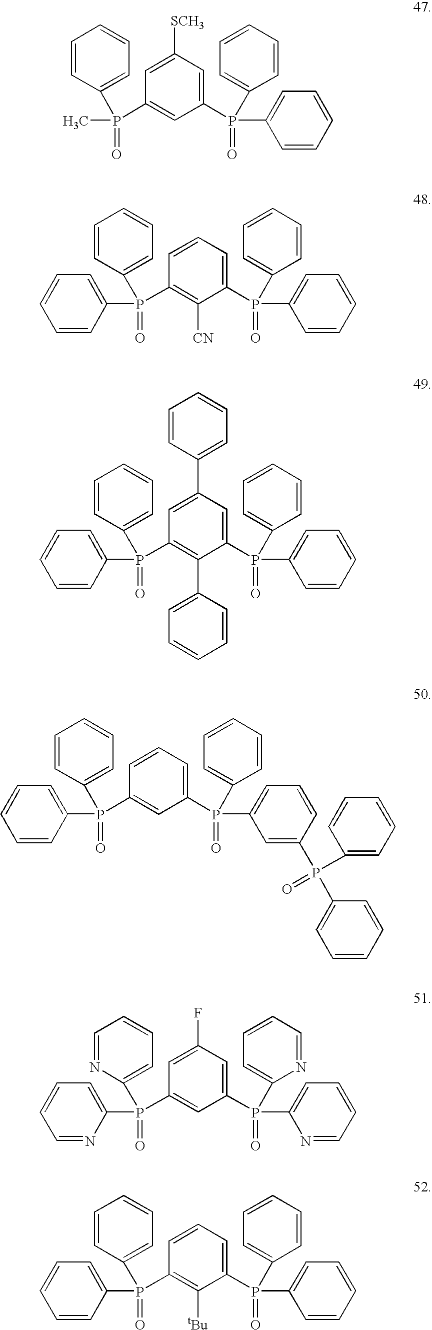

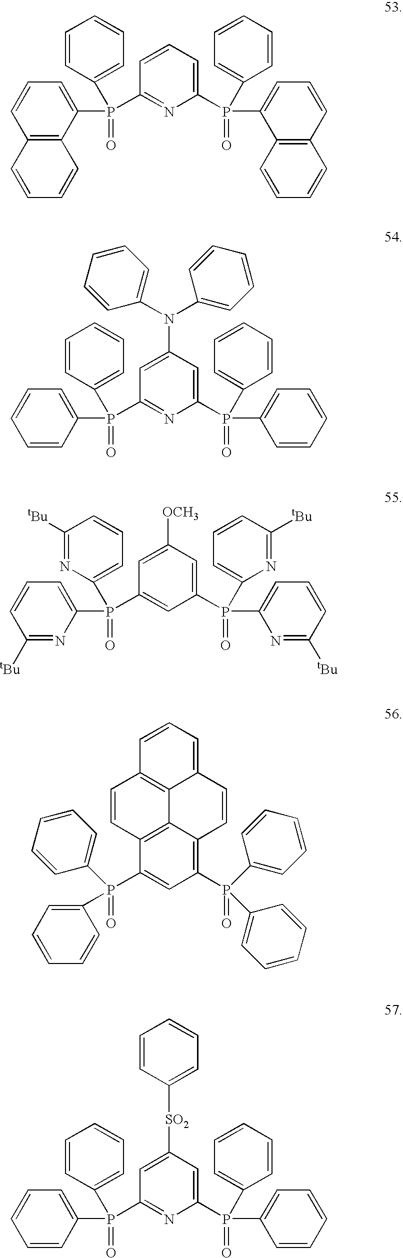

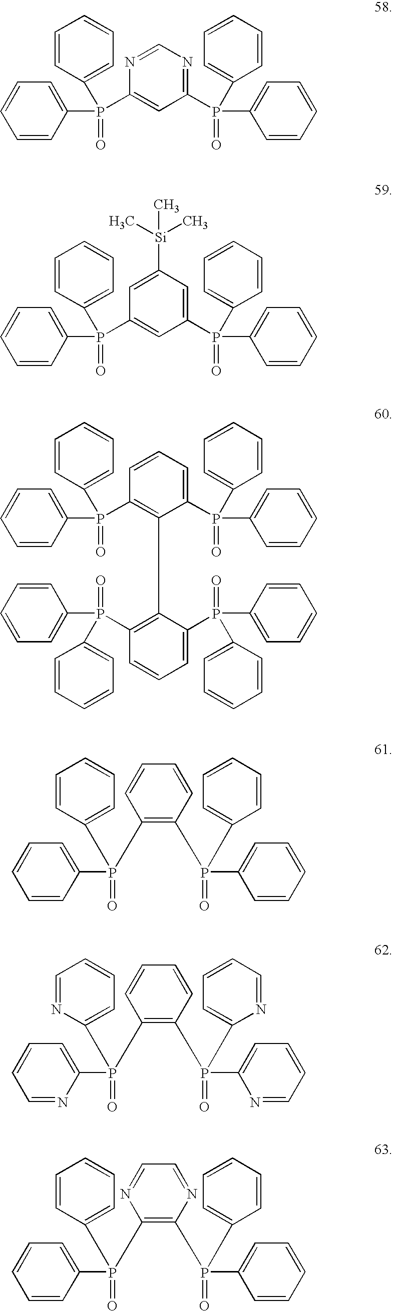

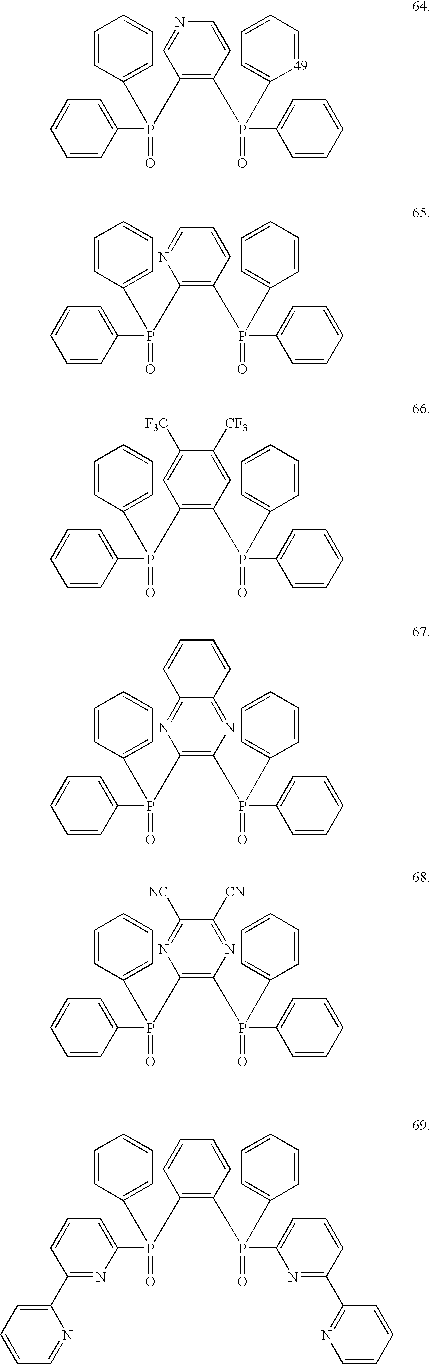

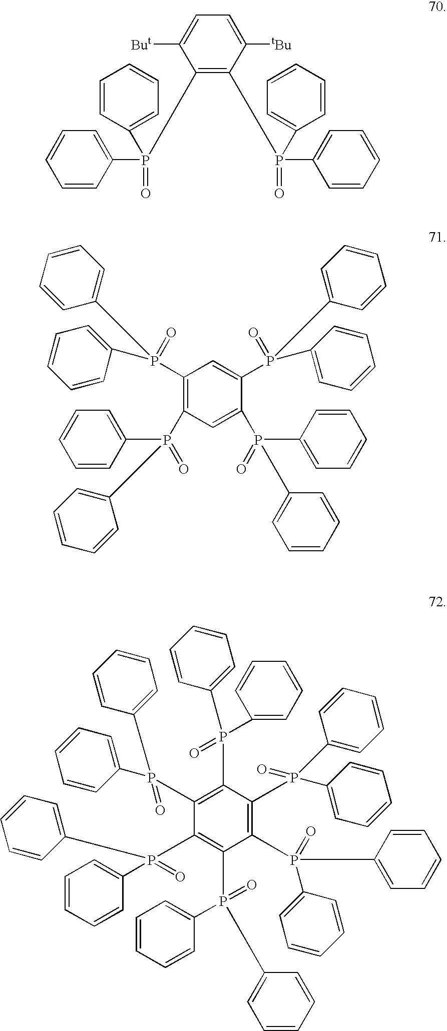

In addition to the above, specific examples of phosphine oxide compounds for use in the invention include, for example, compounds exemplified in JP-A No. 2002-63989, paragraphs from [Kagaku 5] to [Kagaku 7].

### <Application Method>

As a method for forming a layer containing a phosphine oxide compound in the invention, although not particularly limited, such a method is used as a resistance heating deposition method, an electron beam method, a sputtering method, a molecular stacking method, a wet coating system (such as a spray coating method, a dip coating method, an impregnating method, a roll coating method, a gravure coating method, a reverse coating method, a roll brush method, an air knife coating method, a curtain coating method, a spin coating method, a flow coating method, a bar coating method, a microgravure coating method, an air doctor coating method, a blade coating method, a squeeze coating method, a transfer roll coating method, a kiss coating method, a cast coating method, an extrusion coating method, a wire bar coating method, a screen coating method or the like), an ink-jet method, a printing method, a transfer method and the like.

### 2. Organic Electroluminescence Element

Hereinafter, the constitution of the organic electroluminescence element of the invention is described in detail.

The light-emitting element of the invention is an organic electroluminescence element having a cathode and an anode on a substrate, and at least one organic layer containing an organic light-emitting layer (hereinafter, sometimes simply referred to as a “light-emitting layer”) between the two electrodes, wherein the element includes an electron transport layer containing a phosphine oxide compound and an electron transport layer that does not substantially contain the phosphine oxide compound between the light-emitting layer and the cathode, the electron transport layer containing a phosphine oxide compound is nearer to the cathode, and the electron transport layer that does not substantially contain the phosphine oxide compound is nearer to the light-emitting layer. From the nature of a light-emitting element, at least one electrode of the anode and the cathode is preferably transparent.

Preferably, the electron transport layer containing the phosphine oxide compound is a layer which contacts with an electron injection layer.

As an integration pattern of the organic compound layers according to the present invention, it is preferred that the layers are integrated in the order of a hole transport layer, a light-emitting layer, and an electron transport layer from the anode side. Moreover, a charge-blocking layer or the like may be provided between the hole transport layer and the light-emitting layer or between the light-emitting layer and the electron transport layer. In addition, a hole injection layer may be provided between the anode and the hole transport layer, and similarly, an electron injection layer may be provided between the cathode and the electron transport layer. Further, each of the layers may be composed of plural secondary layers.

Next, the components constituting the light-emitting material of the present invention will be described in detail.

### <Substrate>

The substrate to be applied in the invention is preferably one which does not scatter or attenuate light emitted from the organic compound layer. Specific examples of materials for the substrate include zirconia-stabilized yttrium (YSZ); inorganic materials such as glass; polyesters such as polyethylene terephthalate, polybutylene phthalate, and polyethylene naphthalate; and organic materials such as polystyrene, polycarbonate, polyethersulfone, polyarylate, polyimide, polycycloolefin, norbornene resin, polychlorotrifluoroethylene, and the like.

For instance, when glass is used as the substrate, non-alkali glass is preferably used with respect to the quality of material in order to decrease ions eluted from the glass. In the case of employing soda-lime glass, it is preferred to use glass on which a barrier coat of silica or the like has been applied. In the case of employing an organic material, it is preferred to use a material excellent in heat resistance, dimension stability, solvent resistance, electric insulation, and workability.

There is no particular limitation as to the shape, the structure, the size or the like of the substrate, but it may be suitably selected according to the application, purposes and the like of the light-emitting element. In general, a plate-like substrate is preferred as the shape of the substrate. A structure of the substrate may be a monolayer structure or a laminated structure. Furthermore, the substrate may be formed from a single member or two or more members.

Although the substrate may be transparent and colorless, or transparent and colored, it is preferred that the substrate is transparent and colorless from the viewpoint that the substrate does not scatter or attenuate light emitted from the organic light-emitting layer.

A moisture permeation preventive layer (gas barrier layer) may be provided on the front surface or the back surface of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

In the case of applying a thermoplastic substrate, a hard-coat layer or an undercoat layer may be further provided as needed.

### <Anode>

The anode may generally be any material as long as it has a function as an electrode for supplying holes to the organic compound layer, and there is no particular limitation as to the shape, the structure, the size or the like. However, it may be suitably selected from among well-known electrode materials according to the application and purpose of the light-emitting element. As mentioned above, the anode is usually provided as a transparent anode.

Materials for the anode preferably include, for example, metals, alloys, metal oxides, electric conductive compounds, and mixtures thereof. Specific examples of the anode materials include electric conductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electric conductive metal oxides; inorganic electric conductive materials such as copper iodide and copper sulfide; organic electric conductive materials such as polyaniline, polythiophene, and polypyrrole; and laminates of these inorganic or organic electron-conductive materials with ITO. Among these, the electric conductive metal oxides are preferred, and particularly, ITO is preferable in view of productivity, high electric conductivity, transparency and the like.

The anode may be formed on the substrate in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the anode. For instance, when ITO is selected as a material for the anode, the anode may be formed in accordance with a DC or high-frequency sputtering method, a vacuum deposition method, an ion plating method or the like.

In the organic electroluminescence element of the present invention, a position at which the anode is to be formed is not particularly limited, but it may be suitably selected according to the application and purpose of the light-emitting element. The anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, or a lift-off method or a printing method may be applied.

A thickness of the anode may be suitably selected according to the material constituting the anode and is therefore not definitely decided, but it is usually in a range of from 10 nm to 50 μm, and preferably from 50 nm to 20 μm.

A value of resistance of the anode is preferably 10³Ω/□ or less, and more preferably 10²Ω/□. In the case where the anode is transparent, it may be either transparent and colorless, or transparent and colored. For extracting luminescence from the transparent anode side, it is preferred that a light transmittance of the anode is 60% or higher, and more preferably 70% or higher.

Concerning transparent anodes, there is a detailed description in “TOUMEI DENNKYOKU-MAKU NO SHINTENKAI (Novel Developments in Transparent Electrode Films)” edited by Yutaka Sawada, published by C.M.C. in 1999, the contents of which are incorporated by reference herein. In the case where a plastic substrate having a low heat resistance is applied, it is preferred that ITO or IZO is used to obtain a transparent anode prepared by forming the film at a low temperature of 150° C. or lower.

### <Cathode>

The cathode may generally be any material as long as it has a function as an electrode for injecting electrons to the organic compound layer, and there is no particular limitation as to the shape, the structure, the size or the like. However it may be suitably selected from among well-known electrode materials according to the application and purpose of the light-emitting element.

Materials constituting the cathode include, for example, metals, alloys, metal oxides, electric conductive compounds, and mixtures thereof. Specific examples thereof include alkali metals (e.g., Li, Na, K, Cs or the like), alkaline earth metals (e.g., Mg, Ca or the like), gold, silver, lead, aluminum, sodium-potassium alloys, lithium-aluminum alloys, magnesium-silver alloys, rare earth metals such as indium, and ytterbium, and the like. They may be used alone, but it is preferred that two or more of them are used in combination from the viewpoint of satisfying both stability and electron inject-ability.

Among these, as the materials for constituting the cathode, alkaline metals or alkaline earth metals are preferred in view of electron inject-ability, and materials containing aluminum as a major component are preferred in view of excellent preservation stability.

The term “material containing aluminum as a major component” refers to a material constituted by aluminum alone; alloys comprising aluminum and 0.01% by weight to 10% by weight of an alkaline metal or an alkaline earth metal; or the mixtures thereof (e.g., lithium-aluminum alloys, magnesium-aluminum alloys and the like).

Regarding materials for the cathode, they are described in detail in JP-A Nos. 2-15595 and 5-121172, the contents of which are incorporated by reference herein.

A method for forming the cathode is not particularly limited, but it may be formed in accordance with a well-known method.

For instance, the cathode may be formed in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the cathode. For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, or a lift-off method or a printing method may be applied.

In the present invention, a position at which the cathode is to be formed is not particularly limited, and it may be formed on either the whole or a part of the organic compound layer.

Furthermore, a dielectric material layer made of fluorides, oxides or the like of an alkaline metal or an alkaline earth metal may be inserted between the cathode and the organic compound layer with a thickness of 0.1 nm to 5 nm. The dielectric layer may be considered to be a kind of electron injection layer. The dielectric material layer may be formed in accordance with, for example, a vacuum deposition method, a sputtering method, an ion-plating method or the like.

A thickness of the cathode may be suitably selected according to materials for constituting the cathode and is therefore not definitely decided, but it is usually in a range of from 10 nm to 5 μm, and preferably from 50 nm to 1 μm.

Moreover, the cathode may be transparent or opaque. The transparent cathode may be formed by preparing a material for the cathode with a small thickness of 1 nm to 10 nm, and further laminating a transparent electric conductive material such as ITO or IZO thereon.

### <Organic Compound Layer>

The organic electroluminescence element according to the present invention is to be described.

The organic electroluminescence element according to the present invention has at least one organic compound layer including a light-emitting layer. An organic compound layer apart from the light-emitting layer comprises a hole transport layer, an electron transport layer, a charge-blocking layer (a hole-blocking layer, an electron-blocking layer), a hole injection layer, an electron injection layer and the like as described above.

In the organic electroluminescence element of the present invention, the respective layers constituting the organic compound layer can be suitably formed in accordance with any of a dry film-forming method such as a vapor deposition method, or a sputtering method; a wet film-forming method; a transfer method; a printing method; an ink-jet method; or the like.

1) Organic Light-Emitting Layer

The organic light-emitting layer is a layer having functions of receiving holes from the anode, the hole injection layer, or the hole transport layer, and receiving electrons from the cathode, the electron injection layer, or the electron transport layer, and providing a field for recombination of the holes with the electrons to emit a light, when an electric field is applied the layer.

The light-emitting layer according to the present invention preferably contains a light-emitting material and a host material.

The light-emitting material may be a fluorescent light-emitting material or a phosphorescent light-emitting material, and the dopant may be one or a plurality of compounds. Preferably, the light-emitting material is a phosphorescent light-emitting material, and may be a low molecular compound or a high molecular compound.

Preferably, the host material in the present invention is a charge-transporting material, and particularly preferably, a hole-transporting host material. The host material may be one or a plurality of compounds. For example, a mixture of a hole-transporting host material and an electron-transporting host material is preferable. Further, a material which does not emit light nor transport any charge may be use.

The light-emitting layer may be a single layer or a plurality of layers, wherein the layers may emit light with respectively different colors.

(Light-Emitting Material)

Examples of fluorescent light-emitting materials usable in the present invention include, for example, a benzofuran derivative, a benzothiophene derivative, a pyran derivative, a benzoxazole derivative, a benzimidazole derivative, a benzothiazole derivative, a styrylbenzene derivative, a polyphenyl derivative, a diphenylbutadiene derivative, a tetraphenylbutadiene derivative, a naphthalimide derivative, a coumarin derivative, condensed aromatic compounds, a perylene derivative, an oxadiazole derivative, an oxazine derivative, an aldazine derivative, a pyrazine derivative, a cyclopentadiene derivative, a bis-styrylanthracene derivative, a quinacridone derivative, a pyrrolopyridine derivative, a thiadiazolopyridine derivative, a cyclopentadiene derivative, a styrylamine derivative, a diketopyrrolopyrrole derivative, aromatic dimethylidene compounds, a variety of metal complexes represented by metal complexes of an 8-quinolynol derivative or metal complexes of a pyrromethene derivative, polymer compounds such as polythiophene, polyphenylene and polyphenylenevinylene, compounds such as organic silane derivative and the like.

Examples of the phosphorescent light-emitting material which can be used in the invention include complexes containing a transition metal atom or a lanthanoid atom.

For instance, although the transition metal atom is not limited, it is preferably ruthenium, rhodium, palladium, tungsten, rhenium, osmium, iridium, or platinum; and more preferably rhenium, iridium, or platinum. In the present invention, an organic metal complex having platinum as a central metal is most preferable.

Examples of the lanthanoid atom include lanthanum, cerium, praseodymium, neodymium, samarium, europium, gadolinium, terbium, dysprosium, holmium, erbium, thulium, ytterbium, and lutetium, and among these lanthanoid atoms, neodymium, europium, and gadolinium are preferred.

Examples of ligands in the complex include the ligands described, for example, in “Comprehensive Coordination Chemistry” authored by G. Wilkinson et al., published by Pergamon Press Company in 1987; “Photochemistry and Photophysics of Coordination compounds” authored by H. Yersin, published by Springer-Verlag Company in 1987; and “YUHKI KINZOKU KAGAKU—KISO TO OUYOU—(Metalorganic Chemistry—Fundamental and Application—)” authored by Akio Yamamoto, published by Shokabo Publishing Co., Ltd. in 1982.

Specific examples of the ligands include preferably halogen ligands (preferably chlorine ligands), aromatic ligands (e.g., cyclopentadienyl anions, benzene anions, or naphthyl anions and the like), nitrogen-containing heterocyclic ligands (e.g., phenylpyridine, benzoquinoline, isoquinoline, quinolinol, bipyridyl, or phenanthroline and the like), diketone ligands (e.g., acetylacetone and the like), carboxylic acid ligands (e.g., acetic acid ligands, picolinates and the like), carbon monoxide ligands, isonitryl ligands, and cyano ligand, and more preferably nitrogen-containing heterocyclic ligands. The above-described complexes may be either a complex containing one transition metal atom in the compound, or a so-called polynuclear complex containing two or more transition metal atoms wherein different metal atoms may be contained at the same time.

The phosphorescent light-emitting material is contained in an amount of from 0.1% by weight to 40% by weight in the light-emitting layer, and more preferably in an amount of from 0.5% by weight to 30% by weight.

Specific examples of platinum complex used in the present invention include the following compounds, but it should be noted that the present invention is not limited thereto.

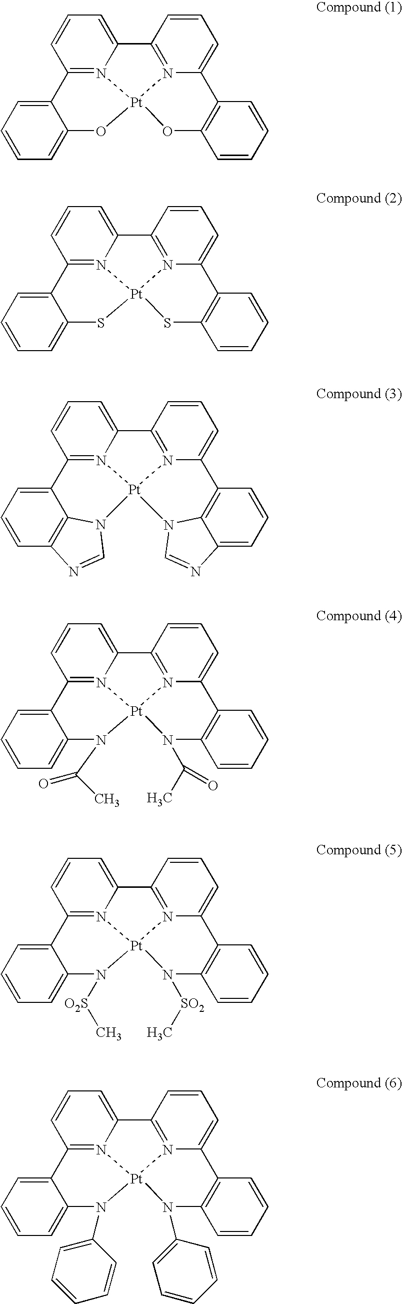

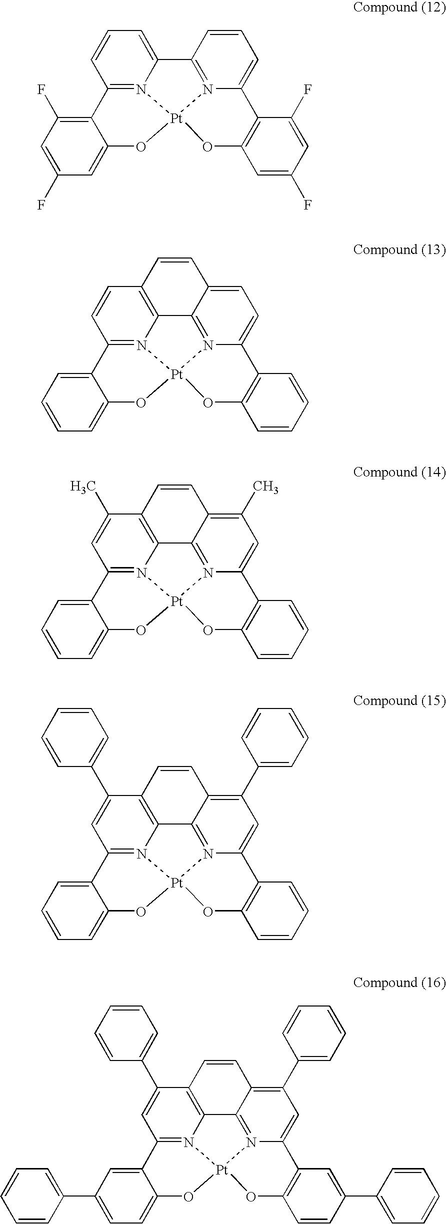

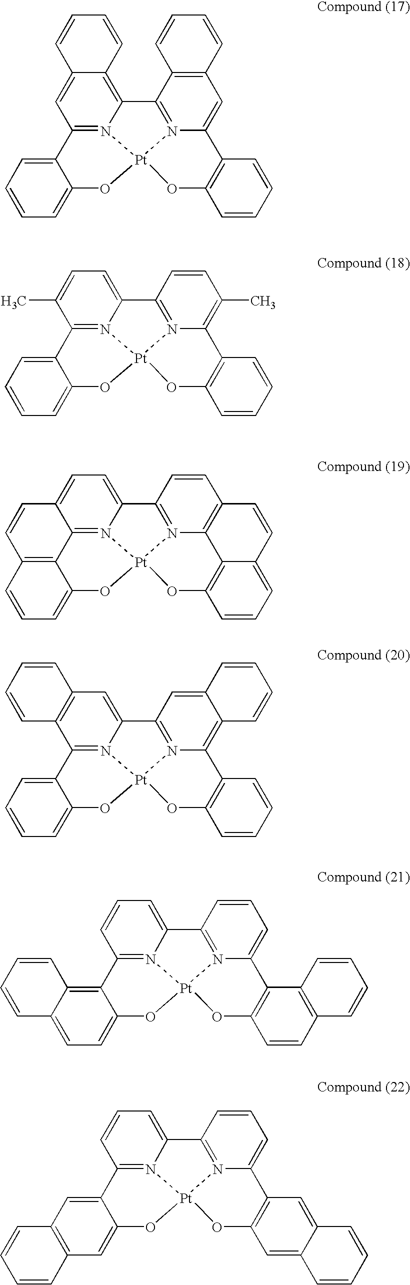

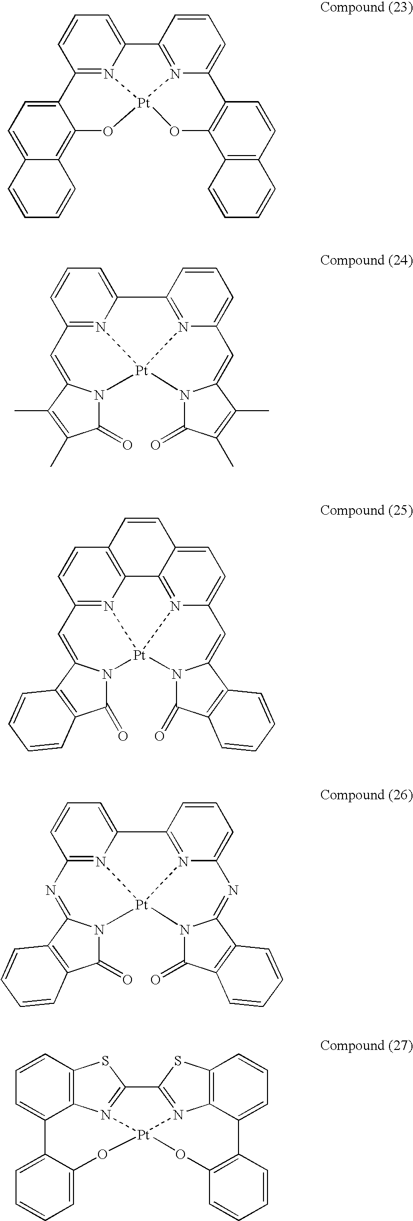

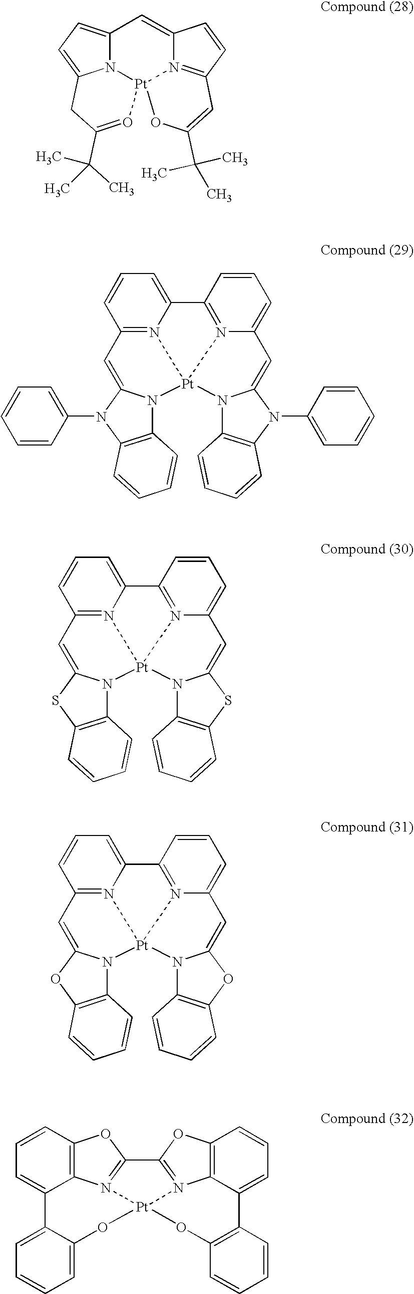

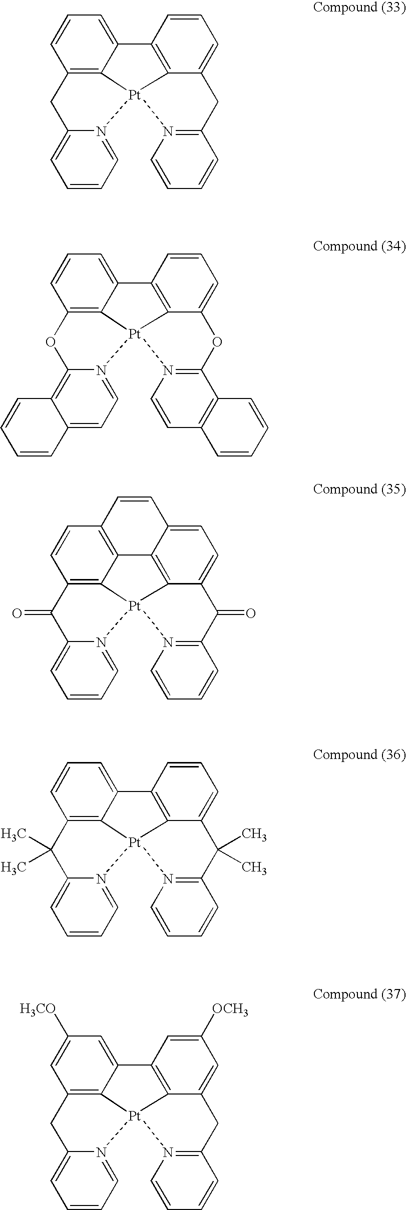

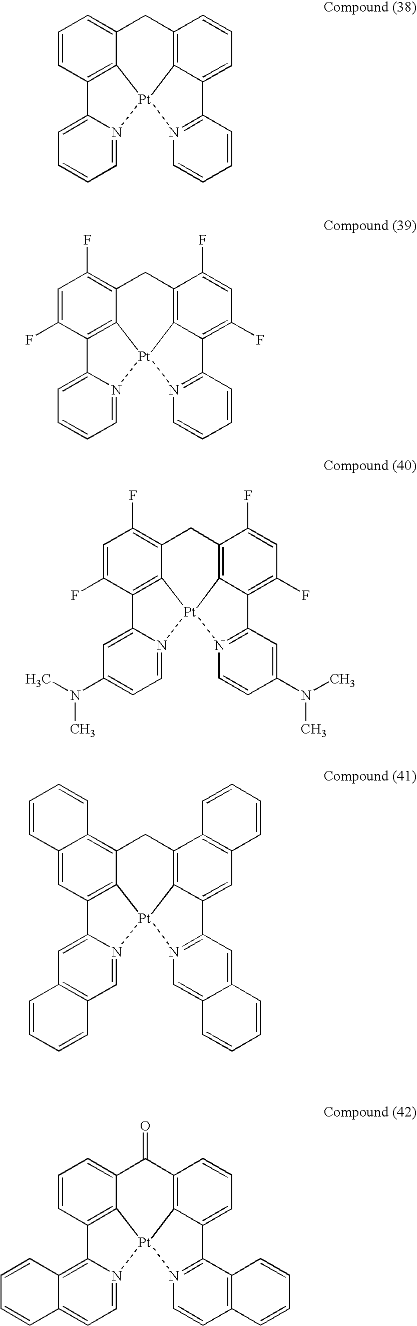

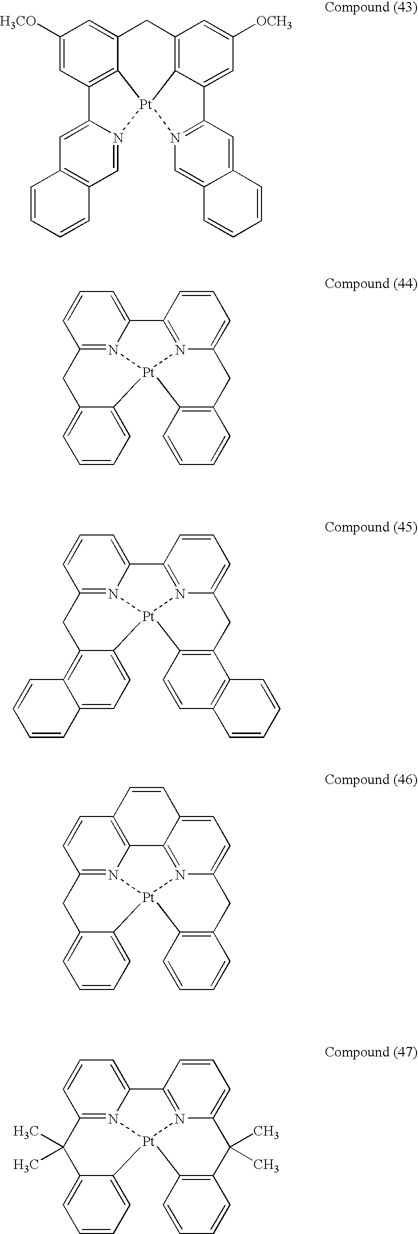

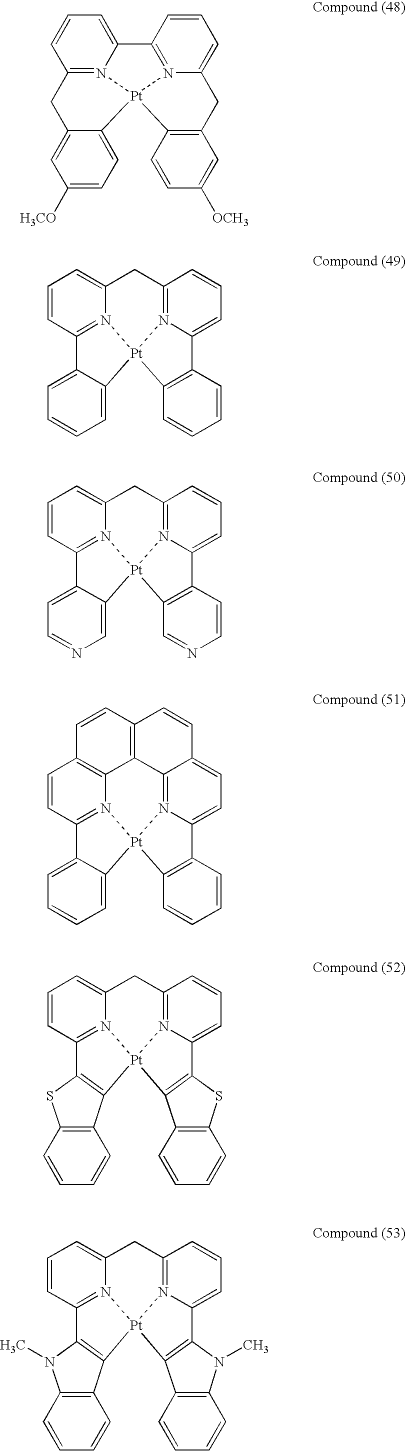

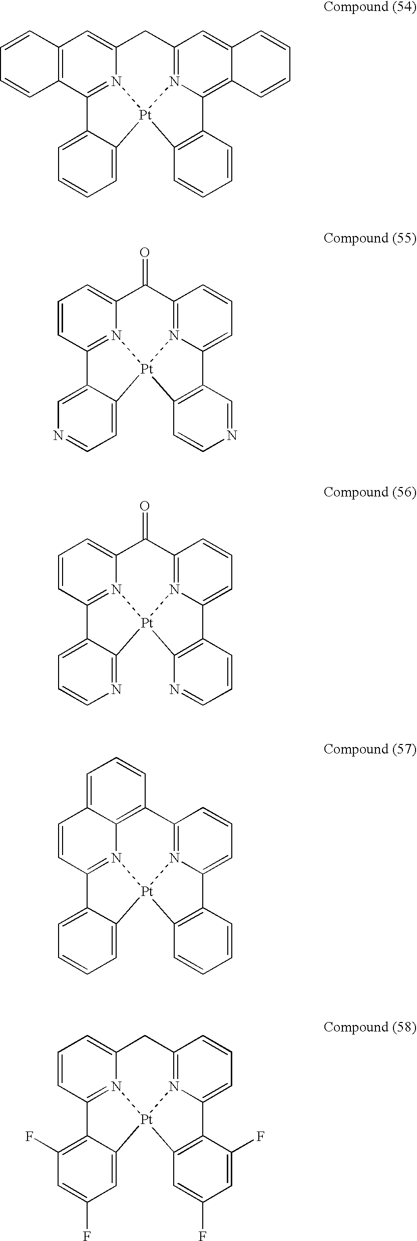

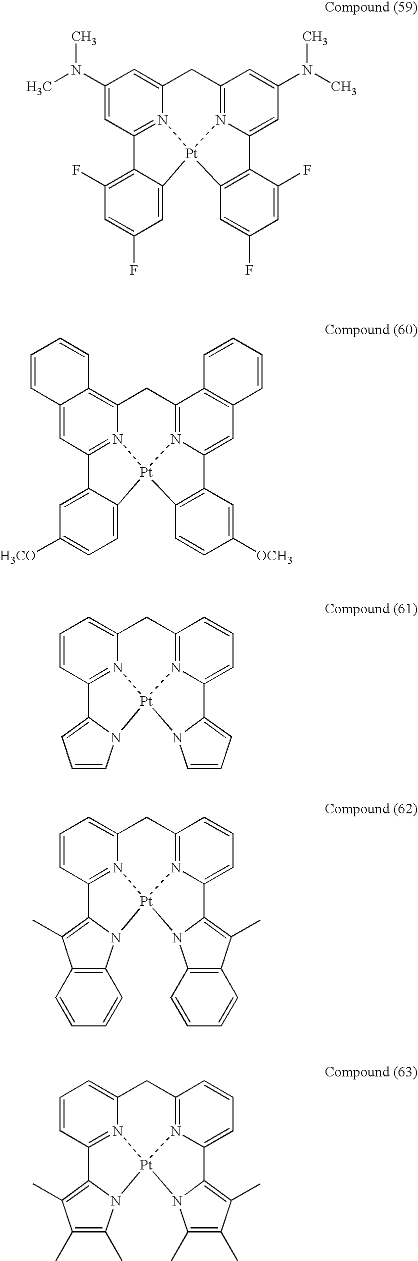

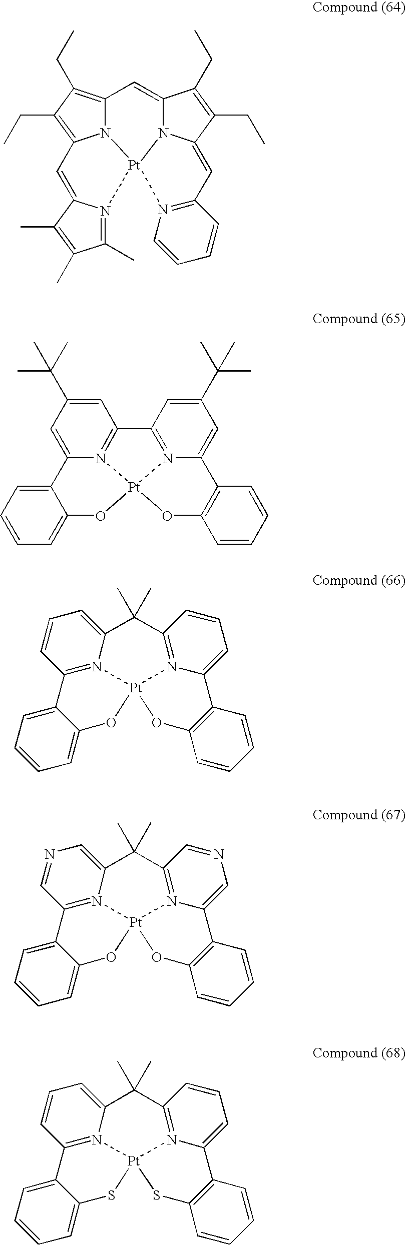

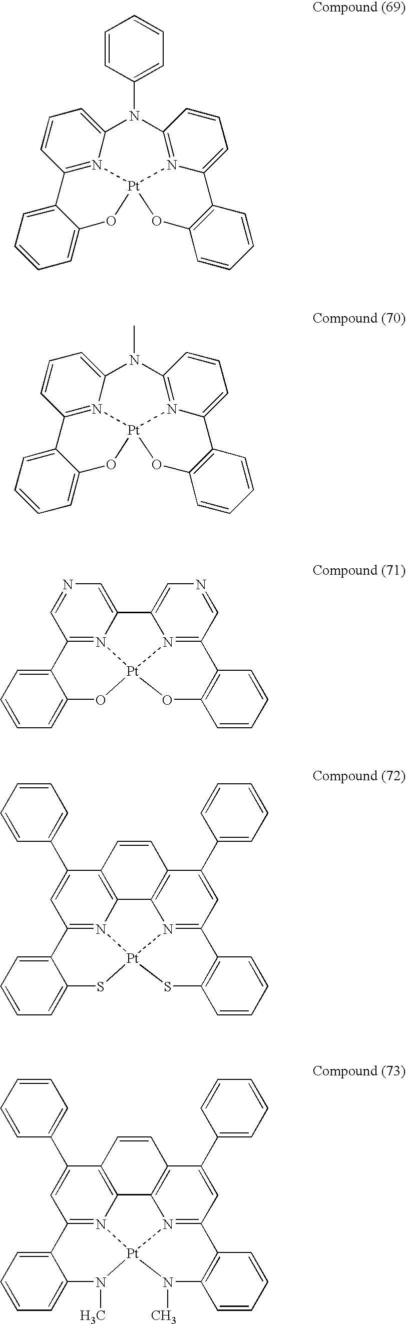

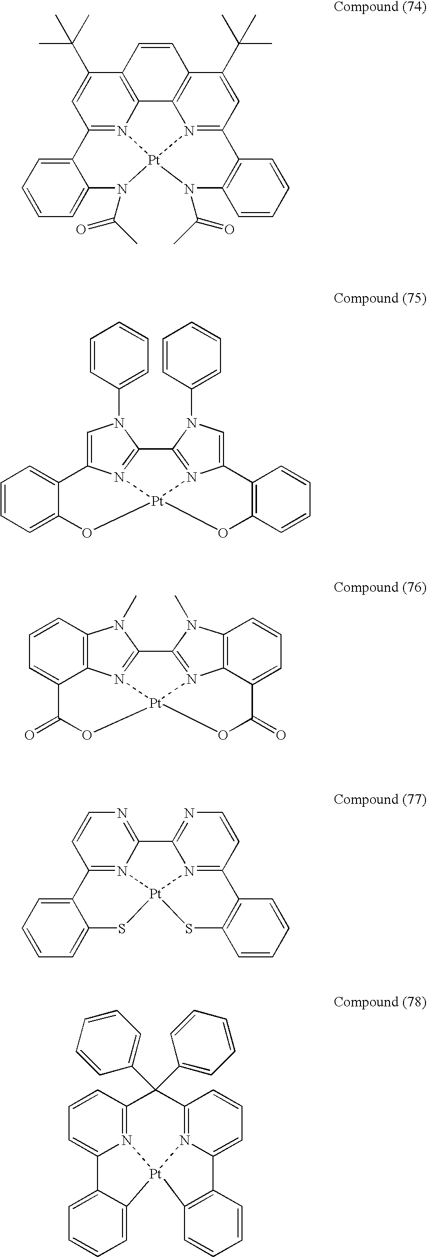

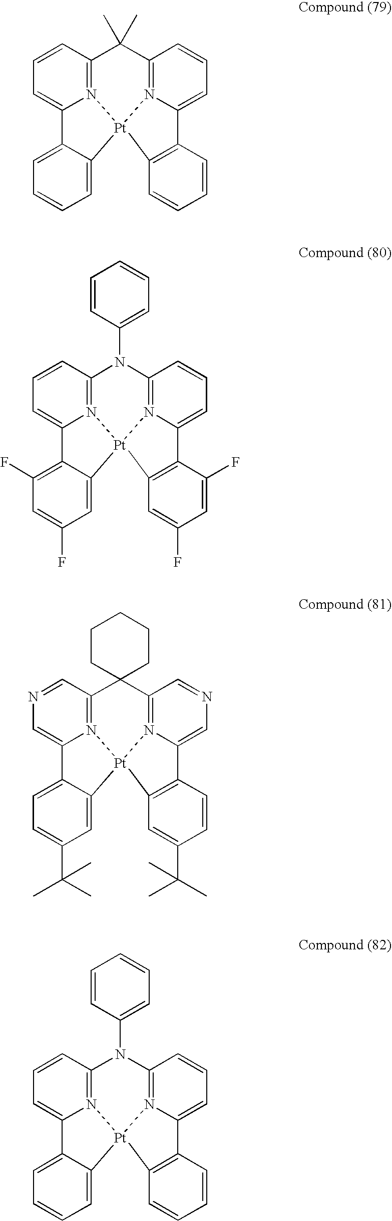

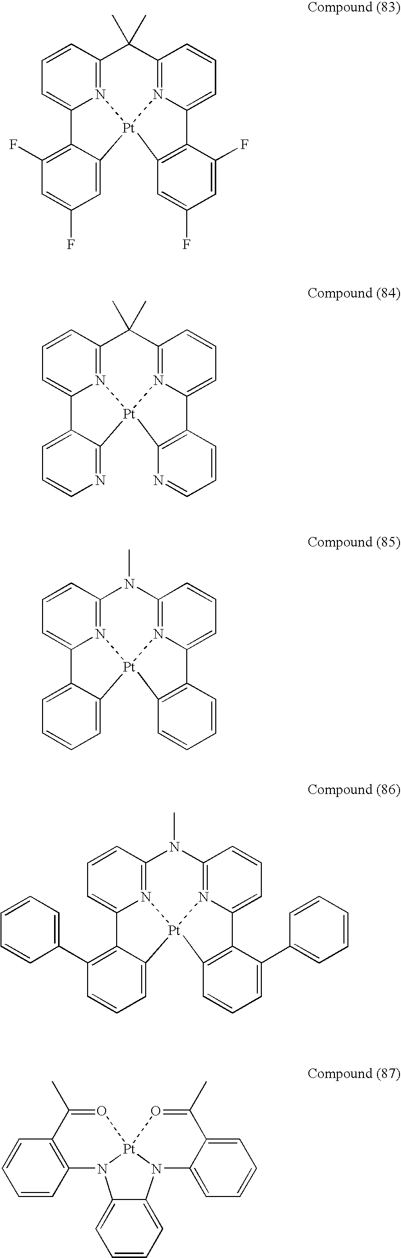

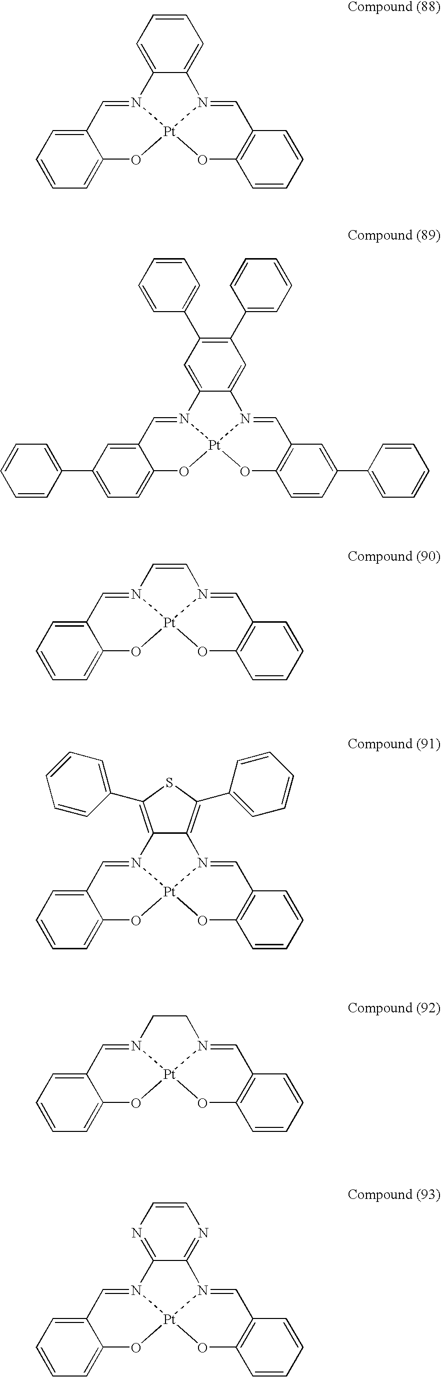

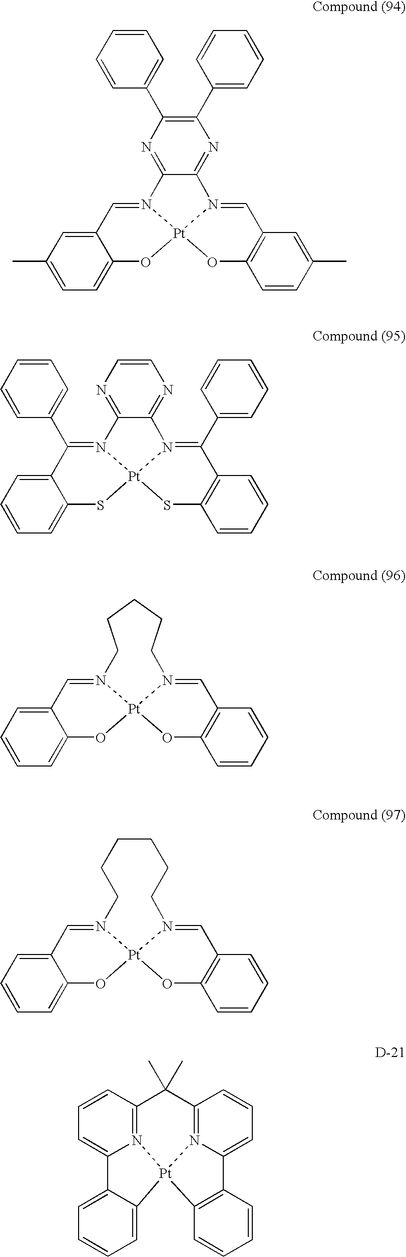

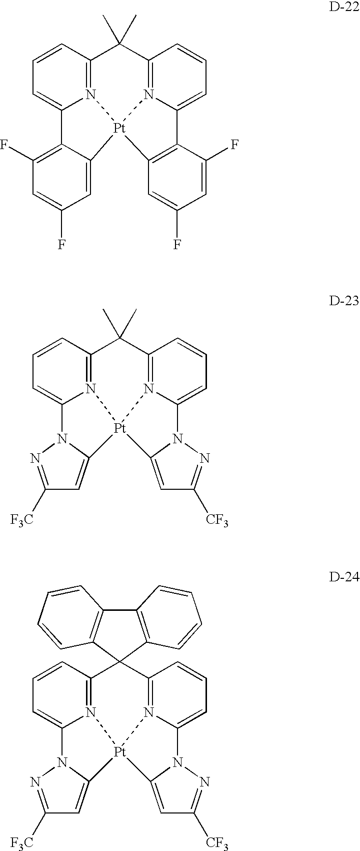

(Host Material)

The host material in the present invention is not specifically limited, but a hole transporting host material is specifically preferable in view of obtaining large effect.

[symbol] Hole Transporting

[symbol]

The hole transporting host used for the organic layer of the present invention preferably has an ionization potential Ip of from 5.1 eV to 6.3 eV, more preferably from 5.4 eV to 6.1 eV, and even more preferably from 5.6 eV to 5.8 eV in view of improvements in durability and decrease in driving voltage. Furthermore, it preferably has an electron affinity Ea of from 1.2 eV to 3.1 eV, more preferably from 1.4 eV to 3.0 eV, and even more preferably from 1.8 eV to 2.8 eV in view of improvements in durability and decrease in driving voltage.

Specific examples of such hole transporting hosts as mentioned above include pyrrole, carbazole, pyrazole, imidazole, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, aromatic dimethylidine compounds, porphyrin compounds, polysilane compounds, poly(N-vinylcarbazole), aniline copolymers, electric conductive polymers or oligomers such as thiophene oligomers, polythiophenes and the like, organic silanes, carbon films, derivatives thereof, and the like.

As specific examples of the hole transporting hosts described above, the following compounds may be listed, but the present invention is not limited thereto.

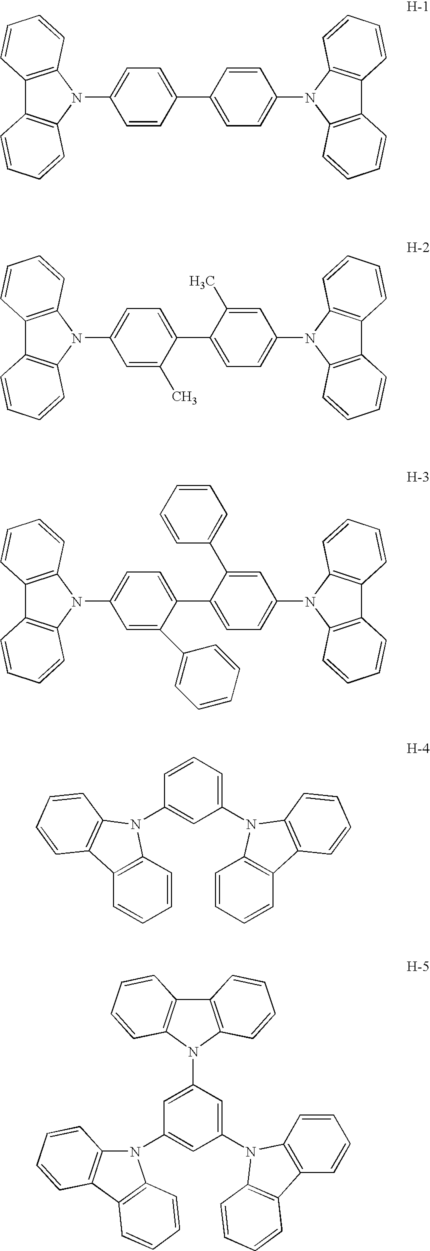

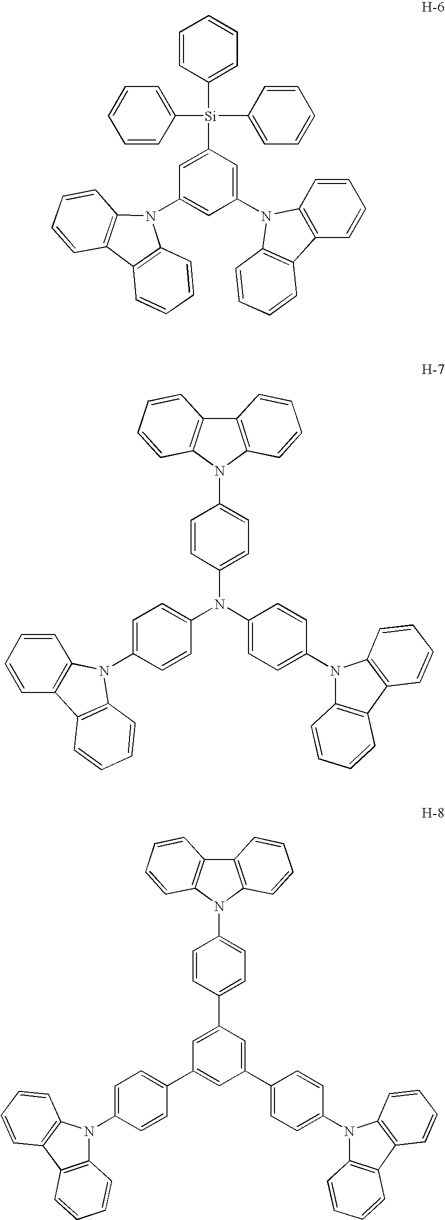

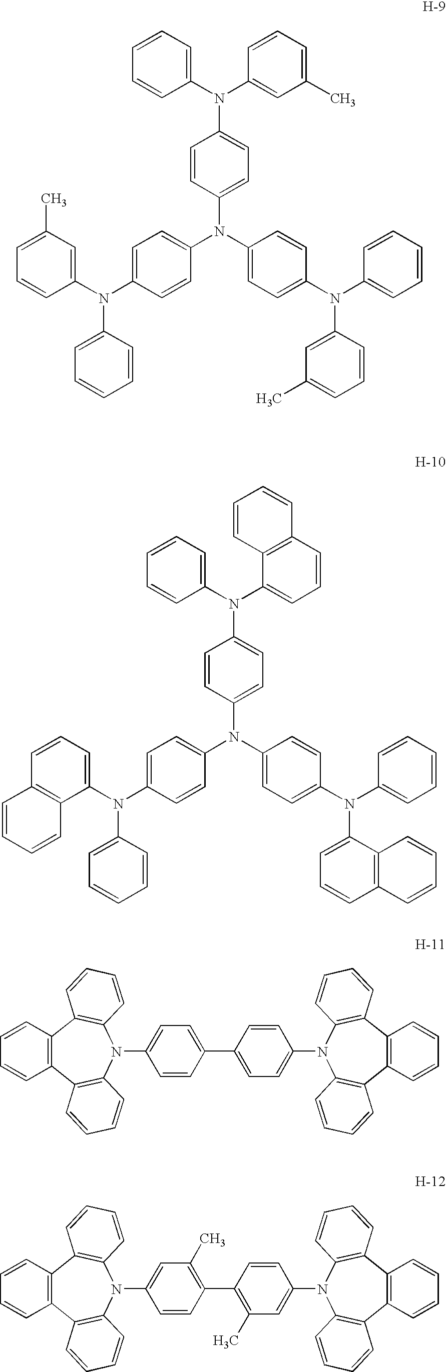

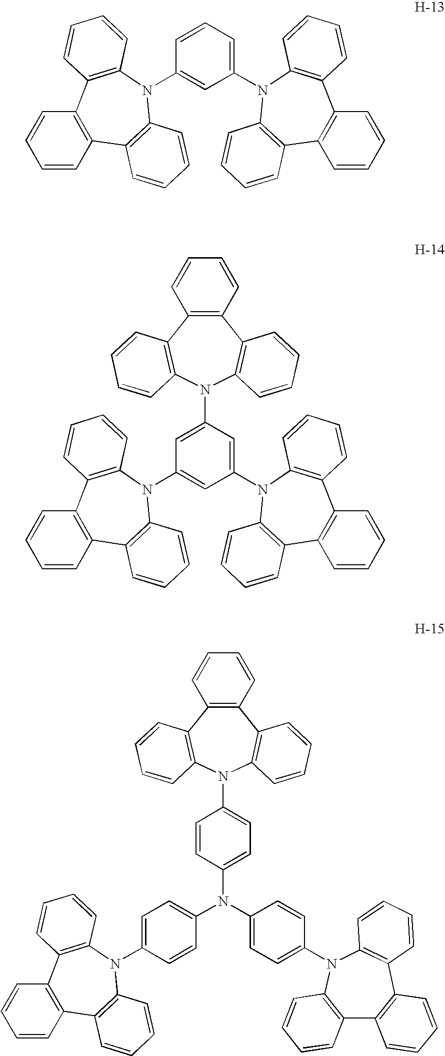

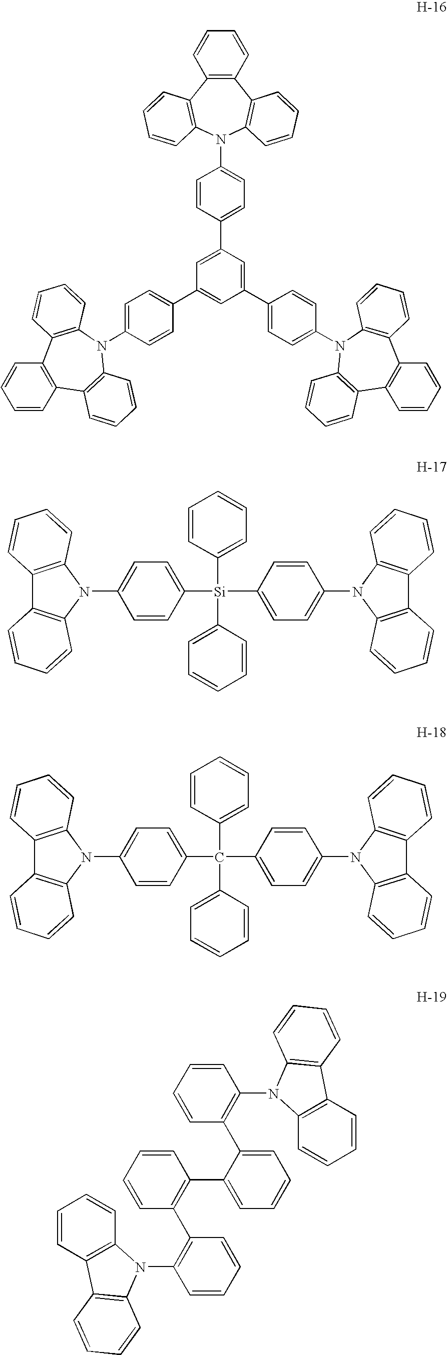

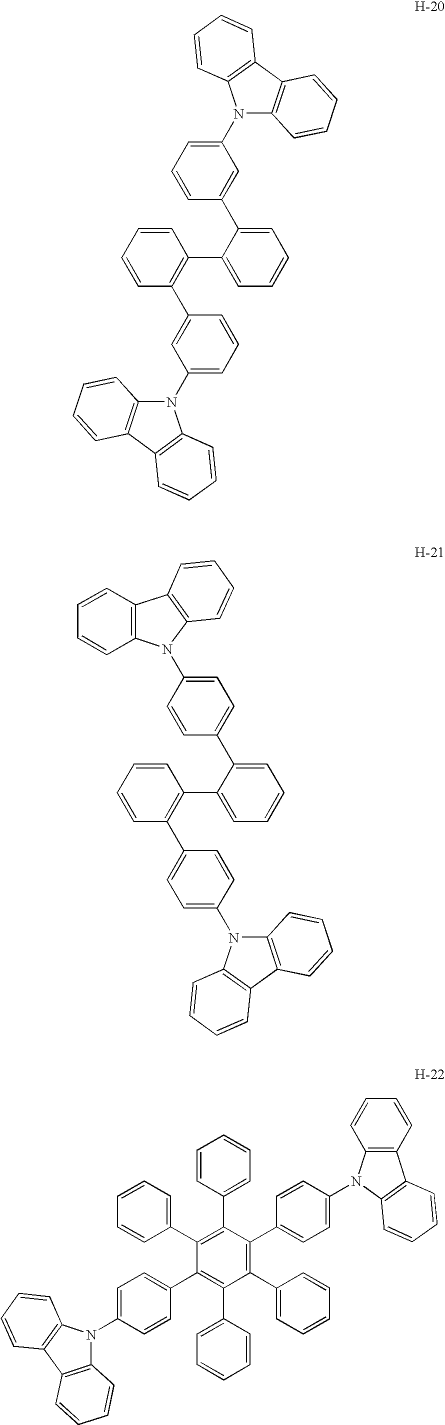

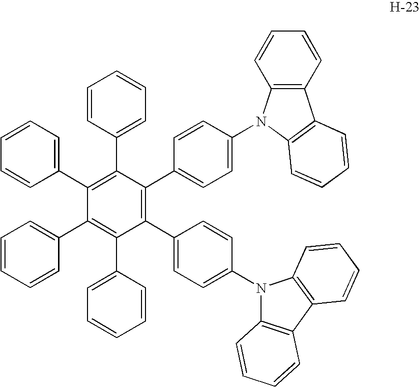

(Thickness pf Light-Emitting Layer)

Although a thickness of the light-emitting layer is not particularly limited, 1 nm to 500 nm is usually preferred, 5 nm to 200 nm is more preferable, and 10 nm to 100 nm is even more preferable.

2) Hole Injection Layer and Hole Transport Layer

The hole injection layer and hole transport layer correspond to layers functioning to receive holes from an anode or from an anode side and to transport the holes to a cathode side. Materials to be introduced into a hole injection layer or a hole transport layer is not particularly limited, but either of a low molecular compound or a high molecular compound may be used.

As a material for the hole injection layer and the hole transport layer, it is preferred to contain specifically pyrrole derivatives, carbazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, phthalocyanine compounds, porphyrin compounds, thiophene derivatives, organosilane derivatives, carbon, metal complexes having a ligand of phenylazole compound or phenylazine, or the like.

An electron-accepting dopant may be introduced into a hole injection layer or a hole transport layer in the organic electroluminescence element of the present invention. As the electron-accepting dopant to be introduced into a hole injection layer or a hole transport layer, either of an inorganic compound or an organic compound may be used as long as the compound has electron accepting property and a function for oxidizing an organic compound.

Specifically, the inorganic compound includes metal halides, such as ferric chloride, aluminum chloride, gallium chloride, indium chloride and antimony pentachloride and the like, and metal oxides, such as vanadium pentaoxide, molybdenum trioxide and the like.

In case of the organic compounds, compounds having a substituent such as a nitro group, a halogen, a cyano group, a trifluoromethyl group or the like; quinone compounds; acid anhydride compounds; fullerenes; and the like may be preferably applied.

Specific examples thereof other than those above include compounds described in patent documents such as JP-A Nos. 6-212153, 11-111463, 11-251067, 2000-196140, 2000-286054, 2000-315580, 2001-102175, 2001-160493, 2002-252085, 2002-56985, 2003-157981, 2003-217862, 2003-229278, 2004-342614, 2005-72012, 2005-166637, 2005-209643 and the like.

These electron-accepting dopants may be used alone or in a combination of two or more of them.

Although an applied amount of these electron-accepting dopants depends on the type of material, 0.01% by weight to 50% by weight is preferred with respect to a hole injection layer material or a hole transport layer material, 0.05% by weight to 20% by weight is more preferable, and 0.1% by weight to 10% by weight is particularly preferred.

A thickness of the hole injection layer and a thickness of the hole transport layer are preferably 500 nm or less, respectively in view of decreasing drive voltage.

The thickness of the hole transport layer is preferably from 1 nm to 500 nm, more preferably is from 5 nm to 200 nm, and even more preferably is from 10 nm to 100 nm. The thickness of the hole injection layer is preferably from 0.1 nm to 200 nm, more preferably is from 0.5 nm to 100 nm, and even more preferably is from 1 nm to 100 nm.

The hole injection layer and the hole transport layer may be composed of a monolayer structure comprising one or two or more of the above-mentioned materials, or a multilayer structure composed of plural layers of a homogeneous composition or a heterogeneous composition.

3) Electron Transport Layer

The electron transport layer is a layer having a function of receiving electrons from the cathode or cathode side and transporting the electrons to the anode side.

The electron transport layer in the invention is characterized in that it includes an electron transport layer containing a phosphine oxide compound and an electron transport layer that does not substantially contain the phosphine oxide compound, wherein the electron transport layer containing a phosphine oxide compound is nearer to the cathode, the electron transport layer that does not substantially contain the phosphine oxide compound is nearer to the light-emitting layer. The term “nearer” in the present invention means that one layer is positioned at relatively closer position to the referred layer than the other layer. In the present invention, among the electron transport layer containing a phosphine oxide compound and the electron transport layer that does not substantially contain the phosphine oxide compound, the electron transport layer that does not substantially contain the phosphine oxide compound is positioned closer to the light-emitting layer. That is, the electron transport layer containing a phosphine oxide compound does not contact with the light-emitting layer, and is positioned closer to the cathode than the electron transport layer that does not substantially contain the phosphine oxide compound is.

Preferably, an electron injection layer is provided between the cathode and the electron transport layer, and the electron transport layer containing the phosphine oxide compound is a layer contacting with the electron injection layer.

In the present invention, the electron transport layer that does not substantially contain the phosphine oxide compound is introduced so as to function to apart the electron transport layer containing the phosphine oxide compound from the light-emitting layer, because the electron transport layer containing the phosphine oxide compound has a harmful influence to degrade drive durability of the element in the case that the electron transport layer containing the phosphine oxide compound is closer to the light-emitting layer. The electron transport layer that does not substantially contain the phosphine oxide compound is formed using electron transporting materials except the phosphine oxide compound. A ratio of an amount of the phosphine oxide compound in a region within 10% in thickness of the electron transport layer closer to the light-emitting layer to a total amount of the phosphine oxide compound in the electron transport layer (the amount of the phosphine oxide compound in the region within 10%/the total amount of the phosphine oxide compound in the electron transport layer) is preferably 0.05 or less, more preferably 0.03 or less, and even more preferably 0.01 or less.

The thickness of the electron transport layer containing the phosphine oxide compound is preferably from 0.01 nm to 10 nm, and more preferably from 0.01 nm to 5 nm. In the case where the thickness is less than 0.01 nm, the effect of accelerating the electron injection is difficult to obtain, that is not preferable. In the case where the thickness exceeds 10 nm, drive voltage increases and drive durability degrades, that is not preferable.

The thickness of the electron transport layer that does not substantially contain the phosphine oxide compound is preferably from 5 nm to 60 nm, and more preferably from 10 nm to 30 nm. In the case where the thickness is less than 5 nm, it is not preferable in view of drive durability, and in the case where the thickness is exceeds 60 nm, it is not preferable in view of drive voltage.

The electron transport layer that does not substantially contain the phosphine oxide compound is not particularly limited, but an organic material generally used as an electron-transporting material may be used. Specific examples thereof include a triazole derivative, an oxazole derivative, an oxadiazole derivative, an imidazole derivative, a fluorenone derivative, an anthraquinodimethane derivative, an anthrone derivative, a diphenylquinone derivative, a thiopyran dioxide derivative, a carbodiimide derivative, a fluorenylidenemethane derivative, a distyrylpyrazine derivative, a tetracarboxylic anhydride of an aromatic compound such as naphthalene or perylene, a phthalocyanine derivative, various metal complexes as typically represented by a metal complex of a 8-quinolinol derivative or metal phthalocyanine, a metal complex containing benzoxazole or benzothiazole as a ligand, or an organic silane derivative and the like.

In the organic EL element of the invention, an electron donating dopant may be contained in the electron transport layer. As a material applied for the electron-donating dopant contained in the electron transport layer, any material may be used as long as it has an electron-donating property and a property for reducing an organic compound, and alkaline metals such as Li, alkaline earth metals such as Mg, transition metals including rare-earth metals and organic reducing compounds are preferably used. Particularly, metals having a work function of 4.2 V or less are preferably applied, and specific examples thereof include Li, Na, K, Be, Mg, Ca, Sr, Ba, Y, Cs, La, Sm, Gd, and Yb. Also examples of the organic reducing compound include a nitrogen-containing compound, a sulfur-containing compound and a phosphorus-containing compound.

In addition, materials described in JP-A Nos. 6-212153, 2000-196140, 2003-68468, 2003-229278 and 2004-342614 may be used.

These electron-donating dopants may be used alone or in a combination of two or more of them.

An applied amount of the electron-donating dopants differs dependent on the types of the materials, but it is preferably from 0.1% by weight to 99% by weight with respect to an electron transport layer material, more preferably from 1.0% by weight to 80% by weight, and particularly preferably from 2.0% by weight to 70% by weight.

4) Hole-Blocking Layer

A hole-blocking layer is a layer having a function to prevent the holes transported from the anode side to the light-emitting layer from passing through to the cathode side. According to the present invention, a hole-blocking layer may be provided as an organic compound layer adjacent to the light-emitting layer on the cathode side.

Examples of the compound constituting the hole-blocking layer include an aluminum complex such as BAlq, a triazole derivative, a phenanthroline derivative such as BCP, or the like.

A thickness of the hole-blocking layer is preferably from 1 nm to 500 nm, more preferably from 5 nm to 200 nm, and even morer preferably from 10 nm to 100 nm.

The hole-blocking layer may have either a monolayer structure comprising one or two or more of the above-mentioned materials, or a multilayer structure composed of plural layers of a homogeneous composition or a heterogeneous composition.

5) Electron-Blocking Layer

An electron-blocking layer is a layer having a function to prevent the electron transported from the cathode side to the light-emitting layer from passing through to the anode side. According to the present invention, an electron-blocking layer may be provided as an organic compound layer adjacent to the light-emitting layer on the anode side.

Specific examples of the compound constituting the electron-blocking layer include compounds explained above as a hole-transporting material.

A thickness of the electron-blocking layer is preferably from 1 nm to 500 nm, more preferably from 5 nm to 200 nm, and even more preferably from 10 nm to 100 nm.

The electron-blocking layer may have either a monolayer structure comprising one or two or more of the above-mentioned materials, or a multilayer structure composed of plural layers of a homogeneous composition or a heterogeneous composition.

6) Electron Injection Layer

In the present invention, an electron injection layer is preferably disposed between the cathode and the electron transport layer, and the electron transport layer containing the phosphine oxide compound contacts with the electron injection layer.

The electron injection layer is a layer by which electrons can be readily injected from the cathode to the electron transport layer. Specifically, lithium salts such as lithium fluoride lithium chloride and lithium bromide; alkali metal salts such as sodium fluoride, sodium chloride and cesium fluoride; and electric insulating metal oxides such as lithium oxide, aluminum oxide, indium oxide and magnesium oxide can be preferably used.

A thickness of the electron injection layer is preferably from 0.1 nm to 5 nm.

### <Protective Layer>

According to the present invention, the whole organic EL element may be protected by a protective layer.

A material contained in the protective layer may be one having a function to prevent penetration of substances such as moisture and oxygen, which accelerate deterioration of the element, into the element.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AlF₃, CaF₂ and the like; polyethylene; polypropylene; polymethylmethacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one comonomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ion plating method, a plasma polymerization method (high-frequency excitation ion plating method), a plasma CVD method, a laser CVD method, a thermal CVD method, a gas source CVD method, a coating method, a printing method, or a transfer method may be applied.

### <Sealing>

The whole organic electroluminescence element of the present invention may be sealed with a sealing cap.

Furthermore, a moisture absorbent or an inert liquid may be used to seal a space defined between the sealing cap and the light-emitting element.

Although the moisture absorbent is not particularly limited, specific examples thereof include barium oxide, sodium oxide, potassium oxide, calcium oxide, sodium sulfate, calcium sulfate, magnesium sulfate, phosphorus pentaoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorine-based solvents such as perfluoroalkanes, perfluoroamines, perfluoroethers and the like; chlorine-based solvents; silicone oils; and the like.

### <Driving>

In the organic electroluminescence element of the present invention, when a DC (AC components may be contained as needed) voltage (usually 2 volts to 15 volts) or DC is applied across the anode and the cathode, luminescence can be obtained. For the driving method of the organic electroluminescence element of the present invention, driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

In the light-emitting element of the present invention, the light-extraction efficiency can be improved by various known methods. It is possible to elevate the light-extraction efficiency and to improve the external quantum efficiency, for example, by modifying the surface shape of the substrate (for example by forming fine irregularity pattern), by controlling the refractive index of the substrate, the ITO layer and/or the organic layer, or by controlling the thickness of the substrate, the ITO layer and/or the organic layer.

The organic electroluminescence element of the present invention may have a so-called top-emission configuration in which the light emission is extracted from the anode side.

### (Application of the Present Invention)

The organic electroluminescence element of the present invention can be appropriately used for indicating elements, displays, backlights, electronic photographs, illumination light sources, recording light sources, exposure light sources, reading light sources, signages, advertising displays, interior accessories, optical communications and the like.

All publications, patent applications, and technical standards mentioned in this specification are herein incorporated by reference to the same extent as if each individual publication, patent application, or technical standard was specifically and individually indicated to be incorporated by reference.

### EXAMPLES

The present invention will be further clarified by way of examples, but the present invention is not limited to such examples.

### Example 1

### Preparation of Organic EL Element

### <Preparation of Comparative Organic EL Element No. 1>

### 1) Formation of Anode

A product (by Tokyo Sanyo Vacuum Industries Co., Ltd.) manufactured by depositing indium tin oxide (hereinafter, referred to as “ITO”) in a thickness of 150 nm to form a film on a 25 mm×25 mm×0.7 mm glass substrate was used as a transparent substrate. The transparent substrate was subjected to etching and washing.

### 2) Hole Injection/Transport Layer

On the ITO glass substrate, 4,4-bis(N-(m-tolyl)-N-phenyl-amino)-biphenyl (hereinafter, referred to as “TPD”) was deposited to give a thickness of 50 nm.

### 3) Light-Emitting Layer

On the hole injection/transport layer, a light-emitting layer containing 4,4′-di-(N-carbazole)-biphenyl (hereinafter, referred to as “CBP”) as a host material and fac-tris-(2-phenylpyridinate-N,C2′) iridium (III) (hereinafter, referred to as “Ir(ppy)₃”) as a light-emitting material was deposited to give a thickness of 50 nm, wherein the amount of Ir(ppy)₃ was 6% by weight with respect to that of CBP.

### 4) Electron Transport Layer

On the light-emitting layer, a phosphine oxide compound A-1 was deposited to give a thickness of 50 nm.

### 5) Electron Injection Layer

In addition, LiF was deposited to give a thickness of 0.5 nm.

### 6) Formation of Cathode

On this layer, a patterned mask (a mask for giving an emitting area of 2 mm×2 mm) was arranged and aluminum was deposited in a thickness of about 200 nm to prepare an element. The prepared element was sealed in a dry glove box.

The above-described deposition was performed under such conditions as a vacuum of from 10⁻³ Pa to 10⁻⁴ Pa and a substrate temperature of room temperature.

### <Preparation of Organic EL Element No. 1 of the Invention>

Organic EL element No. 1 of the invention was prepared in a manner similar to that in preparing the comparative organic EL element No. 1, except for using the following two layers for the electron transport layer in preparing the comparative organic EL element No. 1.

First electron transport layer: a layer that is nearer to the cathode

Phosphine oxide compound A-1 was deposited to give a thickness of 30 nm.

Second electron transport layer: a layer that is nearer to the light-emitting layer

Aluminum (III)-bis-(2-methyl-8-quinolinato)-4-phenylphenolate (hereinafter, referred to as “BAlq”) was deposited to give a thickness of 20 nm.

### <Preparation of Organic EL Element No. 2 of the Invention>

Organic EL element No. 2 of the invention was prepared in a manner similar to that in preparing the comparative organic EL element No. 1, except for using the following two layers for the electron transport layer in preparing the comparative organic EL element No. 1.

First electron transport layer: a layer that is nearer to the cathode

Phosphine oxide compound A-1 was deposited to give a thickness of 10 nm.

Second electron transport layer: a layer that is nearer to the light-emitting layer

BAlq was deposited to give a thickness of 40 nm.

### <Preparation of Organic EL Element No. 3 of the Invention>

Organic EL element No. 3 of the invention was prepared in a manner similar to that in preparing the comparative organic EL element No. 1, except for using the following two layers for the electron transport layer in preparing the comparative organic EL element No. 1.

First electron transport layer: a layer that is nearer to the cathode

Phosphine oxide compound A-1 was evaporated to give a thickness of 3 nm.

Second electron transport layer: a layer that is nearer to the light-emitting layer

BAlq was deposited to give a thickness of 47 nm.

### <Preparation of Organic EL Element No. 4 of the Invention>

Organic EL element No. 4 of the invention was prepared in a manner similar to that in preparing the comparative organic EL element No. 1, except for using the following two layers for the electron transport layer in preparing the comparative organic EL element No. 1.

First electron transport layer: a layer that is nearer to the cathode

Phosphine oxide compound A-1 was deposited to give a thickness of 1 nm.

Second electron transport layer: a layer that is nearer to the light-emitting layer

BAlq was deposited to give a thickness of 49 nm.

Chemical structures of the materials used in Examples are shown below.

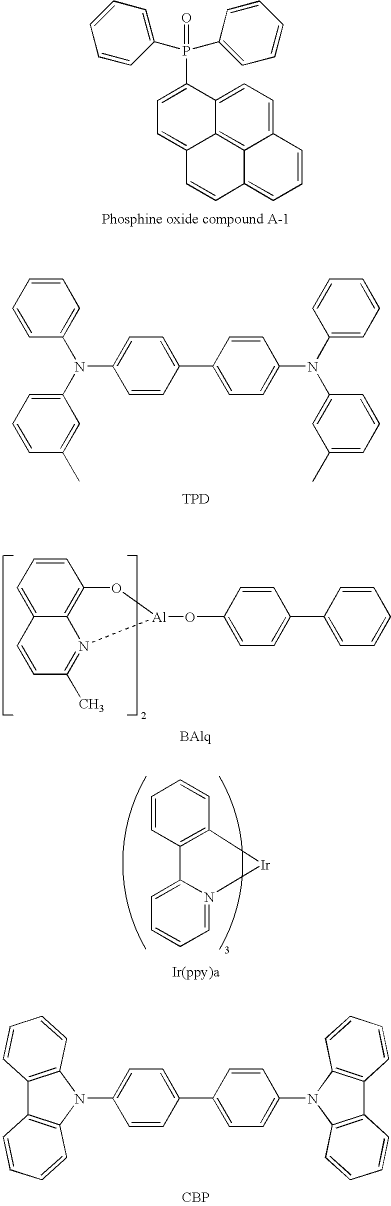

### (Performance Evaluation of Organic EL Element)

### 1) External Quantum Efficiency

Direct current voltage was applied to respective elements using a Source Measure Unit 2400 manufactured by Toyo Technica Corporation to enable them to emit light. The brightness thereof was measured with a brightness meter BM-8 manufactured by TOPCON CORPORATION. Emission spectrum and emission wavelengths were measured with a spectrum analyzer PMA-11 manufactured by Hamamatsu Photonics K. K. On the basis of these numerical values, the external quantum efficiency at the brightness of 1000 cd/m² was calculated by a brightness conversion method.

### 2) Drive Voltage

Direct current voltage was applied to respective elements using a Source Measure Unit 2400 manufactured by Toyo Corporation to enable them to emit light. The voltage when the brightness reached to 1000 cd/m² was measured to give the drive voltage.

3) Drive durability: Brightness Half Decay Time

Each of elements was applied with direct current voltage to give brightness of 1000 cd/m². Then, the element was continuously driven to measure the time until the brightness decreased to 500 cd/m². The brightness half decay time was used as a measure of the drive durability.

Obtained results are listed in Table 1 below.

TABLE 1

| | | | Brightness |
|---|---|---|---|
| | | External quantum | half decay |
| Element No. | Drive voltage (V) | efficiency (%) | time (h) |
| Element 1 for | 17.3 | 7.9 | 10 |
| comparison | | | |
| Element 1 of the | 14.4 | 8.2 | 500 |
| invention | | | |
| Element 2 of the | 13.7 | 8.2 | 1000 |
| invention | | | |
| Element 3 of the | 13.2 | 9.8 | 2500 |
| invention | | | |
| Element 4 of the | 12.9 | 10.1 | 2800 |
| invention | | | |

As is clear from the above results, the elements of the invention showed an increased external quantum efficiency, lowered drive voltage and high drive durability as compared with the comparative element No. 1. In particular, the element Nos. 3 and 4 of the invention showed high drive durability. That is, it is clear that the elements of the invention exert an unexpectedly excellent effect when the thickness of the electron transport layer containing the phosphine oxide compound is in such a thin area as 1 nm or 3 nm.

### Example 2

### Preparation of Organic EL Element

### <Preparation of Comparative Organic EL Element No. 2>

### 1) Formation of Anode

A 25 mm×25 mm×0.7 mm glass substrate, on which ITO was deposited with a thickness of 150 nm (manufactured by Tokyo Sanyo Vacuum Industries Co., Ltd.) was used as a transparent substrate. The transparent substrate was subjected to etching and washing.

### 2) Hole Injection Layer

On this ITO glass substrate, 4,4′,4′-tris(2-naphthylphenylamino)-triphenylamine (which is referred to hereinafter as 2-TNATA in some cases) was so deposited as to obtain a film thickness of 120 nm.

### 3) Hole Transport Layer

On the hole injection layer, N,N′-di-naphthyl-N,N′-diphenyl-[1,1′-biphenyl]-4,4′-diamine (which is referred to hereinafter as α-NPD in some cases) was so deposited as to obtain a film thickness of 10 nm.

### 4) Light-Emitting Layer

On the hole transport layer, 1,3-bis(N-carbazolyl)benzene (which is referred to hereinafter as mCP in some cases) as a host material and iridium (III)-bis-(4,6-(di-fluorophenyl)-pyridinate-N, C2′) picolinate (which is referred to hereinafter as FIrpic in some cases) as a light-emitting material were co-deposited, wherein an amount of FIrpic was 6% by weight with respect to that of mCP. The thickness was 30 nm.

### 5) Electron Transport Layer

On the light-emitting layer, phosphine oxide compound A-2 was deposited to give a thickness of 40 nm.

### 6) Electron Injection Layer

Further, LiF was deposited with a thickness of about 0.5 nm.

### 7) Formation of Cathode

A patterned mask (mask providing a light emission area of 2 mm×2 mm) was provided thereon, and aluminum was deposited with a thickness of about 100 nm to obtain an element. The prepared element was sealed in a dry glove box.

The deposition operations above were executed in vacuum of from 10⁻³ Pa to 10⁻⁴ Pa, with a substrate temperature at the room temperature.

### <Preparation of Comparative Organic EL Element No. 3>

Comparative organic EL element No. 3 was prepared in a similar manner as in the preparation of the comparative organic EL element No. 2, except that the electron transport layer was replaced by the following layer in preparing the comparative organic EL element No. 2.

Electron transport layer: phosphine oxide compound A-2 doped by cesium at an amount of 20% by weight was deposited to give a thickness of 40 nm.

### <Preparation of Organic EL Element No. 5 of the Invention>

Organic EL element No. 5 of the invention was prepared in a manner similar to that in preparing the comparative organic EL element No. 2, except for using the following two layers for the electron transport layer in preparing the comparative organic EL element No. 2.

First electron transport layer: a layer that is nearer to the cathode

Phosphine oxide compound A-2 was deposited to give a thickness of 30 nm.

Second electron transport layer: a layer that is nearer to the light-emitting layer

BAlq was deposited to give a thickness of 10 nm.

### <Preparation of Organic EL Element No. 6 of the Invention>

Organic EL element No. 6 of the invention was prepared in a manner similar to that in preparing the comparative organic EL element No. 2, except for using the following two layers for the electron transport layer in preparing the comparative organic EL element No. 2.

A first electron transport layer: a layer that is nearer to the cathode

Phosphine oxide compound A-2 was evaporated to give a thickness of 10 nm.

A second electron transport layer: a layer that is nearer to the light-emitting layer

BAlq was evaporated to give a thickness of 30 nm.

### <Preparation of Organic EL Element No. 7 of the Invention>

Organic EL element No. 7 of the invention was prepared in a manner similar to that in preparing the comparative organic EL element No. 2, except for using the following two layers for the electron transport layer in preparing the comparative organic EL element No. 2.

First electron transport layer: a layer that is nearer to the cathode

Phosphine oxide compound A-2 was deposited to give a thickness of 3 nm.

Second electron transport layer: a layer that is nearer to the light-emitting layer

BAlq was deposited to give a thickness of 37 nm.

### <Preparation of Organic EL Element No. 8 of the Invention>

Organic EL element No. 8 of the invention was prepared in a manner similar to that in preparing the comparative organic EL element No. 2, except for using the following two layers for the electron transport layer in preparing the comparative organic EL element No. 2.

A first electron transport layer: a layer that is nearer to the cathode

Phosphine oxide compound A-2 was deposited to give a thickness of 1 nm.

A second electron transport layer: a layer that is nearer to the light-emitting layer

BAlq was deposited to give a thickness of 39 nm.

Chemical structures of the materials used in Examples are shown below.

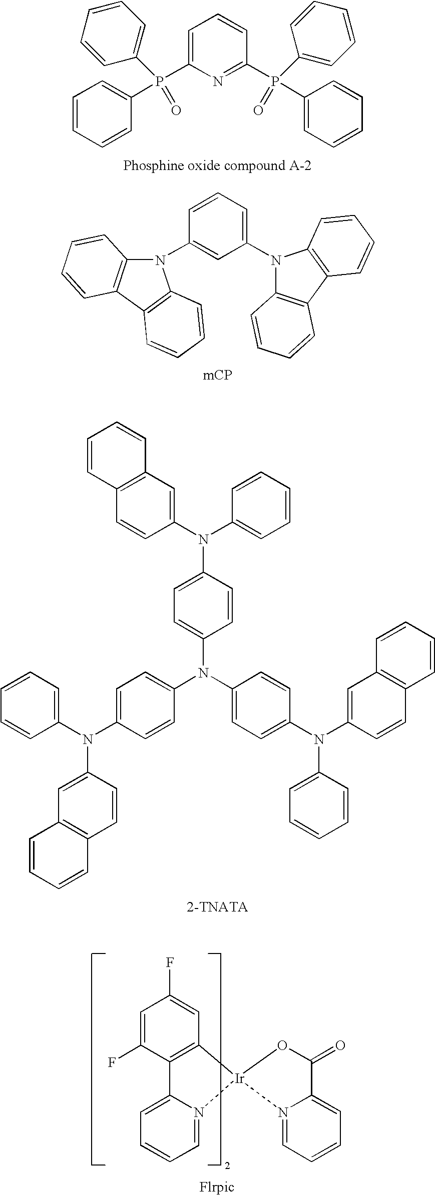

### (Evaluation of Performance of Organic EL Element)

Evaluation was made with respect to the external quantum efficiency, the drive voltage, and the drive durability in a similar manner as in the evaluation of EXAMPLE 1, except that the external quantum efficiency and the drive voltage were measured at brightness of 300 cd/m², and the drive durability was a brightness half decay time at an initial brightness of 300 cd/m².

Obtained results are shown in Table 2.

TABLE 2

| | | | Brightness |
|---|---|---|---|
| | | External quantum | half decay |
| Element No. | Drive voltage (V) | efficiency (%) | time (h) |
| Element 2 for | 17.6 | 5.5 | 10 |
| comparison | | | |
| Element 3 for | 14.3 | 7.2 | 10 |
| comparison | | | |
| Element 5 of the | 15.2 | 8.6 | 200 |
| invention | | | |
| Element 6 of the | 14.5 | 8.6 | 400 |
| invention | | | |
| Element 7 of the | 12.1 | 9.2 | 600 |
| invention | | | |
| Element 8 of the | 12.5 | 9.2 | 600 |
| invention | | | |

As is clear from the above results, the comparative element No. 3 in comparison with the comparative element No. 2 showed increased external quantum efficiency and lowered drive voltage, but drive durability was kept significantly low. On the contrary, the element Nos. 5 to 8 of the invention showed increased external quantum efficiency, lowered drive voltage and unexpectedly extremely high drive durability. In particular, the element Nos. 7 and 8 of the invention showed high drive durability. That is, it is clear that the elements of the invention exert an unexpectedly excellent effect when the thickness of the electron transport layer containing the phosphine oxide compound is in such a thin area as 1 nm or 3 nm.

### Example 3

### Preparation of Organic EL Element

### <Preparation of Comparative Organic EL Element No. 4>

### 1) Formation of Anode

A 25 mm×25 mm×0.7 mm glass substrate, on which ITO was deposited with a thickness of 150 nm (manufactured by Tokyo Sanyo Vacuum Industries Co., Ltd.) was used as a transparent substrate. The transparent substrate was subjected to etching and washing.

### 2) Hole Injection Layer

On the ITO glass substrate, 2-TNATA was so deposited as to obtain a film thickness of 120 nm.

### 3) Hole Transport Layer

On the hole injection layer, α-NPD was so deposited as to obtain a film thickness of 10 nm.

### 4) Light-Emitting Layer

On the hole transport layer, mCP as a host material and platinum complex Pt-1 as a light-emitting material were co-deposited, wherein an amount of Pt-1 was 15% by weight with respect to that of mCP. The thickness was 30 nm.

### 5) Electron Transport Layer

On the Light-emitting layer, phosphine oxide compound A-3 was deposited to give a thickness of 40 nm.

### 6) Electron Injection Layer

Further, LiF was deposited with a thickness of about 0.5 nm.

### 7) Formation of Cathode

A patterned mask (mask providing a light emission area of 2 mm×2 mm) was provided thereon, and aluminum was deposited with a thickness of about 100 nm to obtain an element. The prepared element was sealed in a dry glove box.

The deposition operations above were executed in vacuum of from 10⁻³ Pa to 10⁻⁴ Pa, with a substrate temperature at the room temperature.

### <Preparation of Organic EL Element No. 9 of the Invention>

Organic EL element No. 9 of the invention was prepared in a manner similar to that in preparing the comparative organic EL element No. 4, except for using the following two layers for the electron transport layer in preparing the comparative organic EL element No. 4.

First electron transport layer: a layer that is nearer to the cathode

Phosphine oxide compound A-3 was deposited to give a thickness of 30 nm.

Second electron transport layer: a layer that is nearer to the light-emitting layer

BAlq was deposited to give a thickness of 10 nm.

### <Preparation of Organic EL Element No. 10 of the Invention>

Organic EL element No. 10 of the invention was prepared in a manner similar to that in preparing the comparative organic EL element No. 4, except for using the following two layers for the electron transport layer in preparing the comparative organic EL element No. 4.

First electron transport layer: a layer that is nearer to the cathode

Phosphine oxide compound A-3 was deposited to give a thickness of 10 nm.

Second electron transport layer: a layer that is nearer to the light-emitting layer

BAlq was deposited to give a thickness of 30 nm.

### <Preparation of Organic EL Element No. 11 of the Invention>

Organic EL element No. 11 of the invention was prepared in a manner similar to that in preparing the comparative organic EL element No. 4, except for using the following two layers for the electron transport layer in preparing the comparative organic EL element No. 4.

First electron transport layer: a layer that is nearer to the cathode

Phosphine oxide compound A-3 was deposited to give a thickness of 3 nm.

Second electron transport layer: a layer that is nearer to the light-emitting layer

BAlq was deposited to give a thickness of 37 nm.

### <Preparation of Organic EL Element No. 12 of the Invention>

Organic EL element No. 12 of the invention was prepared in a manner similar to that in preparing the comparative organic EL element No. 4, except for using the following two layers for the electron transport layer in preparing the comparative organic EL element No. 4.

First electron transport layer: a layer that is nearer to the cathode

Phosphine oxide compound A-3 was deposited to give a thickness of 1 nm.

Second electron transport layer: a layer that is nearer to the light-emitting layer

BAlq was deposited to give a thickness of 39 nm.

Chemical structures of the materials used in Examples are shown below.

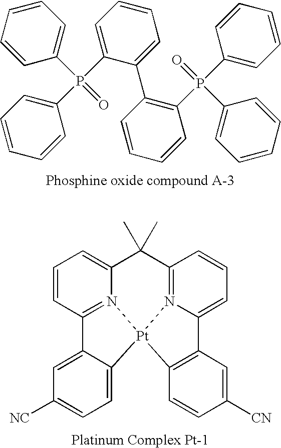

### (Evaluation of Performance of Organic EL Element)

Evaluation was made with respect to the external quantum efficiency, the drive voltage, and the drive durability in a similar manner as in the evaluation of EXAMPLE 1.

Obtained results are shown in Table 3.

TABLE 3

| | | | Brightness |
|---|---|---|---|
| | | External quantum | half decay |
| Element No. | Drive voltage (V) | efficiency (%) | time (h) |
| Element 4 for | 14.3 | 10.5 | 20 |
| comparison | | | |
| Element 9 of the | 12.3 | 10.6 | 500 |
| invention | | | |
| Element 10 of the | 12.1 | 11.6 | 1000 |
| invention | | | |
| Element 11 of the | 10.2 | 13.0 | 3000 |
| invention | | | |
| Element 12 of the | 9.8 | 13.1 | 3000 |
| invention | | | |

As is clear from the above results, the element Nos. 9 to 12 of the invention showed an increased external quantum efficiency, lowered drive voltage and high drive durability as compared with the comparative element No. 4. In particular, the element Nos. 11 and 12 of the invention showed high drive durability. That is, it is clear that the elements of the invention exert an unexpectedly excellent effect when the thickness of the electron transport layer containing the phosphine oxide compound is in such a thin area as 1 nm or 3 nm. It is shown that the combination of an electron transport layer using a phosphine oxide compound and a light-emitting layer using a platinum complex exerts unexpectedly excellent effect.

### Example 4

### Preparation of Organic EL Element

### <Preparation of Comparative Organic EL Element No. 5>

### 1) Formation of Anode

A 25 mm×25 mm×0.7 mm glass substrate, on which ITO was deposited with a thickness of 150 nm (manufactured by Tokyo Sanyo Vacuum Industries Co., Ltd.) was used as a transparent substrate. The transparent substrate was subjected to etching and washing.

### 2) Hole Injection Layer

On the ITO glass substrate, 2-TNATA was so deposited as to obtain a film thickness of 120 nm.

### 3) Hole Transport Layer

On the hole injection layer, α-NPD was so deposited as to obtain a film thickness of 10 nm.

### 4) Light-Emitting Layer

On the hole transport layer, mCP as a host material and platinum complex Pt-2 as a light-emitting material were co-deposited, wherein an amount of Pt-2 was 15% by weight with respect to that of mCP. The thickness was 30 nm.

### 5) Electron Transport Layer

On the light-emitting layer, phosphine oxide compound A-4 was deposited to give a thickness of 40 nm.

### 6) Electron Injection Layer

Further, LiF was deposited with a thickness of about 0.5 nm.

### 7) Formation of Cathode

A patterned mask (mask providing a light emission area of 2 mm×2 mm) was provided thereon, and aluminum was deposited with a thickness of about 100 nm to obtain an element. The prepared element was sealed in a dry glove box.

The deposition operations above were executed in vacuum of from 10⁻³ to Pa 10⁻⁴ Pa, with a substrate temperature at the room temperature.

### <Preparation of Organic EL Element No. 13 of the Invention>

Organic EL element No. 13 of the invention was prepared in a manner similar to that in preparing the comparative organic EL element No. 5, except for using the following two layers for the electron transport layer in preparing the comparative organic EL element No. 5.

First electron transport layer: a layer that is nearer to the cathode

Phosphine oxide compound A-4 was evaporated to give a thickness of 30 nm.

Second electron transport layer: a layer that is nearer to the light-emitting layer

BAlq was deposited to give a thickness of 10 nm.

### <Preparation of Organic EL Element No. 14 of the Invention>

Organic EL element No. 14 of the invention was prepared in a manner similar to that in preparing the comparative organic EL element No. 5, except for using the following two layers for the electron transport layer in preparing the comparative organic EL element No. 5.

First electron transport layer: a layer that is nearer to the cathode

Phosphine oxide compound A-4 was deposited to give a thickness of 10 nm.

Second electron transport layer: a layer that is nearer to the light-emitting layer

BAlq was deposited to give a thickness of 30 nm.

### <Preparation of Organic EL Element No. 15 of the Invention>

Organic EL element No. 15 of the invention was prepared in a manner similar to that in preparing the comparative organic EL element No. 5, except for using the following two layers for the electron transport layer in preparing the comparative organic EL element No. 5.

First electron transport layer: a layer that is nearer to the cathode

Phosphine oxide compound A-4 was deposited to give a thickness of 3 nm.

Second electron transport layer: a layer that is nearer to the light-emitting layer

BAlq was deposited to give a thickness of 37 nm.

### <Preparation of Organic EL Element No. 16 of the Invention>

Organic EL element No. 16 of the invention was prepared in a manner similar to that in preparing the comparative organic EL element No. 5, except for using the following two layers for the electron transport layer in preparing the comparative organic EL element No. 5.

First electron transport layer: a layer that is nearer to the cathode

Phosphine oxide compound A-4 was deposited to give a thickness of 1 nm.

Second electron transport layer: a layer that is nearer to the light-emitting layer

BAlq was deposited to give a thickness of 39 nm.

Chemical structures of the materials used in Examples are shown below.

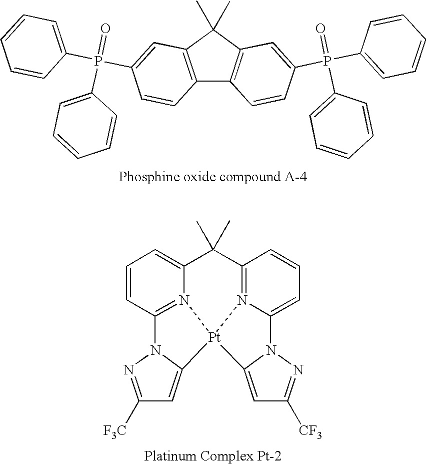

### (Evaluation of Performance of Organic EL Element)

Evaluation was made with respect to the external quantum efficiency, the drive voltage, and the drive durability in a similar manner as in the evaluation of EXAMPLE 1.

Obtained results are shown in Table 4.

TABLE 4

| | | | Brightness |
|---|---|---|---|
| | | External quantum | half decay |
| Element No. | Drive voltage (V) | efficiency (%) | time (h) |
| Element 5 for | 16.2 | 5.9 | 10 |
| comparison | | | |
| Element 13 of the | 14.6 | 6.8 | 300 |
| invention | | | |
| Element 14 of the | 13.9 | 6.8 | 600 |
| invention | | | |
| Element 15 of the | 12.6 | 8.2 | 900 |
| invention | | | |
| Element 16 of the | 12.6 | 8.6 | 1000 |
| invention | | | |

As is clear from the above results, the element Nos. 13 to 16 of the invention showed an increased external quantum efficiency, lowered drive voltage and high drive durability as compared with the comparative element No. 5. In particular, the element Nos. 15 and 16 of the invention showed high drive durability. That is, it is clear that the elements of the invention exert an unexpectedly excellent effect when the thickness of the electron transport layer containing the phosphine oxide compound is in such a thin area as 1 nm or 3 nm.

What is claimed is:

1. An organic electroluminescence element comprising at least one organic layer including a light-emitting layer between a pair of electrodes, wherein the organic electroluminescence element includes an electron transport layer containing a phosphine oxide compound and an electron transport layer that does not substantially contain the phosphine oxide compound between the light-emitting layer and a cathode, the electron transport layer containing the phosphine oxide compound is nearer to the cathode, and the electron transport layer that does not substantially contain the phosphine oxide compound is nearer to the light-emitting layer.

2. The organic electroluminescence element according to claim 1, wherein an electron injection layer is disposed between the electron transport layer containing a phosphine oxide compound and the cathode, and the electron transport layer containing the phosphine oxide compound contacts with the electron injection layer.

3. The organic electroluminescence element according to claim 1, wherein a thickness of the electron transport layer containing the phosphine oxide compound is from 0.01 nm to 10 nm.

4. The organic electroluminescence element according to claim 3, wherein the thickness of the electron transport layer containing the phosphine oxide compound is from 0.01 nm to 5 nm.

5. The organic electroluminescence element according to claim 1, wherein the phosphine oxide compound is a compound represented by the following formula (I): 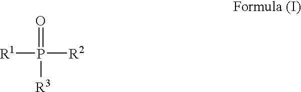
wherein R¹, R² and R³ each independently represent an alkyl group, an alkenyl group, an alkynyl group, an aryl group, an amino group, an alkoxy group, an aryloxy group, a heterocyclic oxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a heterocyclic thio group or a heterocyclic group.

6. The organic electroluminescence element according to claim 5, wherein the phosphine oxide compound represented by formula (I) is a compound represented by the following formula (II): 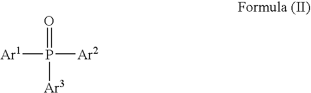
wherein Ar¹, Ar² and Ar³ each independently represent an aryl group or a heterocyclic group.

7. The organic electroluminescence element according to claim 1, wherein the phosphine oxide compound is a compound represented by the following formula (III): 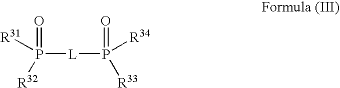
wherein R³¹ to R³⁴ each independently represent an aryl group or a heterocyclic group, and L represents a divalent linking group.

8. The organic electroluminescence element according to claim 1, wherein the light-emitting layer contains a phosphorescent light-emitting material.

9. The organic electroluminescence element according to claim 8, wherein the phosphorescent light-emitting material comprises an organic metal complex including platinum as a central metal.

10. The organic electroluminescence element according to claim 1, wherein the light-emitting layer contains a hole transporting organic material as a host material.
